(19) United States
(12) Patent Application Publication
(10) Pub. No.: US 2026/0290165 A1
(43) Pub. Date: Sep. 24, 2026

(54) METHOD FOR TRANSMITTING AND RECEIVING DATA IN INTELLIGENT TRANSPORT SYSTEM, AND APPARATUS FOR PERFORMING SAME

(71) Applicant: LG Electronics Inc., Seoul (KR)

(72) Inventors: Yoonjong LEE, Seoul (KR); Heejin KIM, Seoul (KR); Jaihyun BYUN, Seoul (KR)

(21) Appl. No.: 19/476,446

(22) PCT Filed: May 8, 2024
(86) PCT No.: PCT/KR2024/006170

§ 371 Date: Oct. 17, 2025

(30) Foreign Application Priority Data
May 9, 2023 (KR) 10-2023-0059520
Jun. 13, 2023 (KR) 10-2023-0075345

(51) Int. Cl. G08G 1/0967; H04W 4/029; H04W 4/44

(52) U.S. Cl. CPC G08G 1/096766; H04W 4/029; H04W 4/44

(57) ABSTRACT

A method for transmitting information by a first device to a second device in an intelligent transport system (ITS) according to at least one of various embodiments may comprise: collecting sensing data about a moving object; obtaining information about a movement path of the object on the basis of the sensing data; generating a message for sharing the sensing data about the object; and transmitting the message to the second device, wherein the message includes N data sets configured on the basis of the information about the movement path of the object, and the N data sets are related to a location of the object at each of N different time points.

### TECHNICAL FIELD

The present disclosure relates to an intelligent transportation system (ITS), and more specifically, to a method and apparatus for transmitting/receiving data related to moving objects in an ITS.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

An Intelligent Transport System (ITS) is a form in which wireless communication technology is applied to achieve more efficient management of transportation systems and enhanced safety. The ITS may monitor traffic conditions in real time and collect and process data through Closed-Circuit Television (CCTV), sensor networks, Global Positioning System (GPS) devices, and wireless communication systems. The ITS may support communication between vehicles. For example, vehicles may communicate with each other and share information on surrounding environments for autonomous driving and improved traffic safety.

### DISCLOSURE

### Technical Problem

An object of the present disclosure is to transmit/receive data related to moving objects more accurately and efficiently in an intelligent transportation system (ITS).

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

In an aspect of the present disclosure, provided herein is a method of transmitting information to a second device by a first device in an intelligent transportation system (ITS). The method may include: collecting sensing data regarding a moving object; acquiring information regarding a movement path of the object based on the sensing data; generating a message for sharing the sensing data regarding the object; and transmitting the message to the second device. The message may include N data sets configured based on the information regarding the movement path of the object, and the N data sets may be related to a position of the object at each of N different time points.

The position of the object at each of the N different time points may be determined by the first device based on the information regarding the movement path of the object.

The movement path of the object may be a path along which the object is predicted to move, and the N data sets may be related to the position of the object predicted at N future time points.

The movement path of the object may be a path of movement history of the object, and the N data sets may be related to the position of the object at N past time points.

The sensing data regarding the moving object may be acquired from vehicle-to-everything (V2X) messages received from other devices.

The message may include information regarding a confidence level for the N data sets configured based on the movement path of the object.

The message may further include at least one data set configured based on the sensing data in addition to the N data sets.

The message may include information for distinguishing whether each data set is a data set configured based on the information regarding the movement path or a data set configured based on the sensing data.

The sensing data may include first sensing data acquired within sensing coverage of the first device and second sensing data acquired outside the sensing coverage of the first device.

The second sensing data may be received from another device having sensing coverage different from the sensing coverage of the first device.

In another aspect of the present disclosure, provided herein is a computer-readable recording medium having recorded thereon a program for executing the above-described method.

In a further aspect of the present disclosure, provided herein is a first device configured to operate in an ITS. The first device includes: a memory configured to store instructions; and a processor configured to perform operations by executing the instructions. The operations performed by the processor may include: collecting sensing data regarding a moving object; acquiring information regarding a movement path of the object based on the sensing data; generating a message for sharing the sensing data regarding the object; and transmitting the message to a second device. The message may include N data sets configured based on the information regarding the movement path of the object, and the N data sets may be related to a position of the object at each of N different time points.

The first device may be a user equipment (UE), a vehicle, a road side unit (RSU), or a server.

### Advantageous Effects

According to an embodiment of the present disclosure, transmission/reception of data related to moving objects may be performed more accurately and efficiently in an intelligent transportation system (ITS).

The effects obtainable from the present disclosure are not limited to the effects described above, and other effects not described may be clearly understood by those skilled in the art to which the present disclosure belongs from the description below.

### BRIEF DESCRIPTION OF THE DRAWINGS

FIG. 1 is a diagram for explaining vehicle-to-everything (V2X) communication.

FIG. 2 illustrates a radio protocol architecture for sidelink (SL) communication.

FIG. 3 illustrates UEs performing V2X or SL communication.

FIG. 4 illustrates examples of various message conversions using a sensor data sharing message format.

FIG. 5 illustrates an example of message sorting.

FIG. 6 illustrates an example of selecting a V2X message including path-history and path-prediction information.

FIG. 7 illustrates an example of selecting a V2X message not including path-history and path-prediction information.

FIG. 8 illustrates an example of Collective Perception Message (CPM) path-history representation.

FIG. 9 illustrates an example of CPM path-prediction representation.

FIG. 10 illustrates an example of CPM path-history representation.

FIG. 11 is a diagram for explaining a data processing procedure for providing path-history/prediction information.

FIG. 12 illustrates an example of a method of using detected objects and received V2X messages for improving/extending sensor coverage.

FIG. 13 illustrates an example of message classification.

FIG. 14 illustrates an example of CPM representation.

FIG. 15 illustrates an example of a procedure of processing input for a sensor data sharing message format.

FIG. 16 illustrates a flow of a method in which a first device transmits data [1] in an intelligent transportation system (ITS) according to an embodiment.

FIG. 17 illustrates a communication system applied to the present disclosure.

FIG. 18 illustrates wireless devices applicable to the present disclosure.

FIG. 19 illustrates another example of a wireless device to which the present disclosure is applied.

FIG. 20 illustrates a vehicle or an autonomous driving vehicle applied to the present disclosure.

### DETAILED DESCRIPTION

A sidelink (SL) refers to a communication method in which a direct link is established between user equipment (UE), and voice or data is directly exchanged between UEs without going through a base station (BS). SL is being considered as one way to solve the burden of the base station due to the rapidly increasing data traffic.

V2X (vehicle-to-everything) refers to a communication technology that exchanges information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

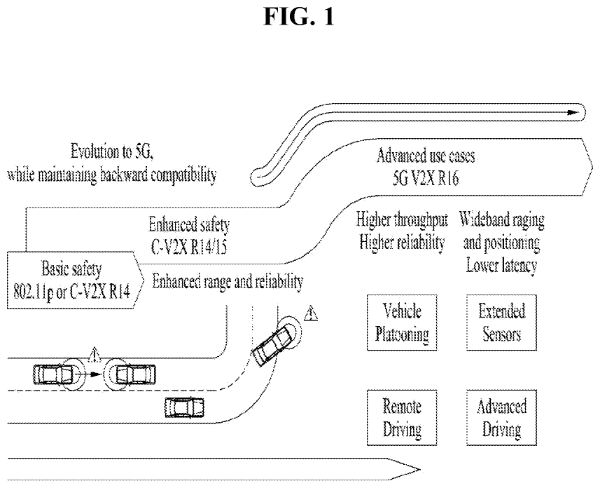

FIG. 1 is a diagram comparing RAT-based V2X communication before NR with NR-based V2X communication.

Regarding V2X communication, in RAT prior to NR, a scheme for providing a safety service based on V2X messages such as a basic safety message (BSM), a cooperative awareness message (CAM), and a decentralized environmental notification message (DENM) was mainly discussed. The V2X message may include location information, dynamic information, and attribute information. For example, the UE may transmit a periodic message type CAM and/or an event triggered message type DENM to another UE.

For example, the CAM may include dynamic state information about a vehicle such as direction and speed, vehicle static data such as dimensions, and basic vehicle information such as external lighting conditions and route details. For example, a UE may broadcast the CAM, and the CAM latency may be less than 100 ms. For example, when an unexpected situation such as a breakdown of the vehicle or an accident occurs, the UE may generate a DENM and transmit the same to another UE. For example, all vehicles within the transmission coverage of the UE may receive the CAM and/or DENM. In this case, the DENM may have a higher priority than the CAM.

Regarding V2X communication, various V2X scenarios have been subsequently introduced in NR. For example, the various V2X scenarios may include vehicle platooning, advanced driving, extended sensors, and remote driving.

For example, based on vehicle platooning, vehicles may dynamically form a group and move together. For example, to perform platoon operations based on vehicle platooning, vehicles belonging to the group may receive periodic data from a leading vehicle. For example, the vehicles belonging to the group may reduce or increase the distance between the vehicles based on the periodic data.

For example, based on advanced driving, a vehicle may be semi-automated or fully automated. For example, each vehicle may adjust trajectories or maneuvers based on data acquired from local sensors of nearby vehicles and/or nearby logical entities. Also, for example, each vehicle may share driving intention with nearby vehicles.

For example, on the basis of extended sensors, raw data or processed data acquired through local sensors, or live video data may be exchanged between a vehicle, a logical entity, UEs of pedestrians and/or a V2X application server. Thus, for example, the vehicle may recognize an environment that is improved over an environment that may be detected using its own sensor.

For example, for a person who cannot drive or a remote vehicle located in a dangerous environment, a remote driver or V2X application may operate or control the remote vehicle based on remote driving. For example, when a route is predictable as in the case of public transportation, cloud computing-based driving may be used to operate or control the remote vehicle. For example, access to a cloud-based back-end service platform may be considered for remote driving.

A method to specify service requirements for various V2X scenarios such as vehicle platooning, advanced driving, extended sensors, and remote driving is being discussed in the NR-based V2X communication field.

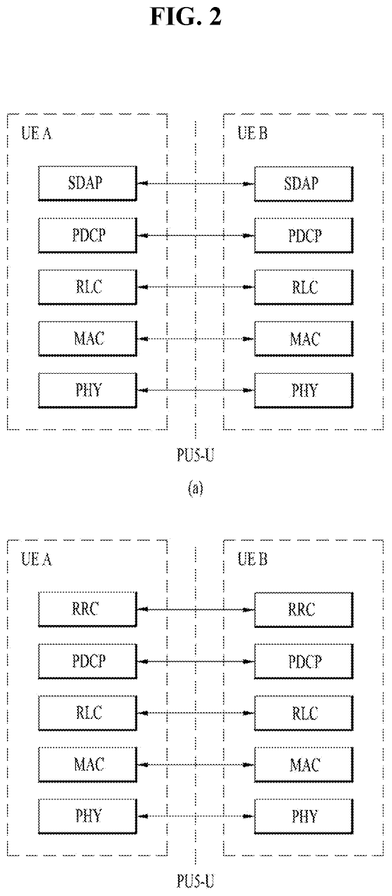

FIG. 2 illustrates a radio protocol architecture for SL communication. Specifically, FIG. 2-(a) shows a user plane protocol stack of NR, and FIG. 2-(b) shows a control plane protocol stack of NR.

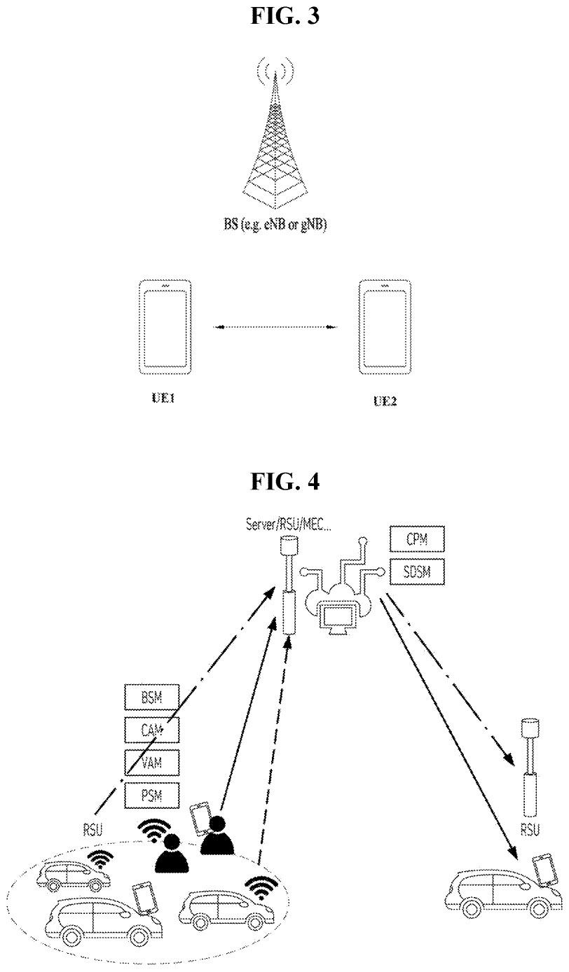

FIG. 3 illustrates UEs performing V2X or SL communication.

Referring to FIG. 3, in V2X or SL communication, the term UE may mainly refer to a user's UE. However, when network equipment such as a BS transmits and receives signals according to a communication scheme between UEs, the BS may also be regarded as a kind of UE. For example, UE 1 may be the first device 100, and UE 2 may be the second device 200.

For example, UE 1 may select a resource unit corresponding to a specific resource in a resource pool, which represents a set of resources. Then, UE 1 may transmit an SL signal through the resource unit. For example, UE 2, which is a receiving UE, may receive a configuration of a resource pool in which UE 1 may transmit a signal, and may detect a signal of UE 1 in the resource pool.

Here, when UE 1 is within the connection range of the BS, the BS may inform UE 1 of a resource pool. On the other hand, when the UE 1 is outside the connection range of the BS, another UE may inform UE 1 of the resource pool, or UE 1 may use a preconfigured resource pool.

In general, the resource pool may be composed of a plurality of resource units, and each UE may select one or multiple resource units and transmit an SL signal through the selected units.

Meanwhile, a sensor data sharing service is a service of sharing surrounding environment information obtained by sensors mounted on vehicles and Road Side Units (RSUs) using V2X communication.

Vehicles and RSUs may extend the sensing range of service users and enhance traffic safety by sharing information on the current driving environment (e.g., road users not supporting V2X communication and obstacles) detected by sensors thereof (e.g., radar, Light Detection and Ranging (LiDAR), infrared, camera, and fusion data), thereby increasing the recognition rate of road conditions including blind spots.

To support a sensor data sharing service using V2X communication technology, Society of Automotive Engineers (SAE) International has defined a Sensor Data Sharing Message (SDSM) in the J3224 standard document, and the European Telecommunications Standards Institute (ETSI) has defined a Collective Perception Message (CPM) in the TS 103 324 standard document.

The term “sensor data sharing message format” used in the present specification may refer to an SDSM or a CPM, but the present disclosure is not limited thereto.

Although there are differences in the types and ranges of information that may be included in the SDSM and CPM, both the SDSM and CPM may commonly include information on one or more non-V2X road users (vehicles without V2X capability or Vulnerable Road Users (VRUs)) or road-specific features (objects or obstacles) detected by a vehicle or an RSU, as well as static information (e.g., size and type) and dynamic information (e.g., position, speed, direction, and acceleration) of the detected objects (vehicles, VRUs, obstacles). In addition, based on the maximum number of objects capable of being included, the SDSM may include up to 256 objects (size of DF_DetectedObjectList), while the CPM may include up to 128 objects (size of PerceivedObjectContainer).

The CPM may include information on used sensors (e.g., sensor type and measurement range). In this case, if the SensorType field is set to itssaggregation, not only directly detected sensor data but also messages (e.g., CAM, BSM, PSM, and VAM) received from multiple ITS stations (ITS components of vehicle, VRU, RSU, and center) may be included and aggregated to generate and transmit the CPM.

A method of using aggregation messages is generally related to services provided from the infrastructure side and ITS central systems. From various overseas cases of ITS data linkage services and demonstration deployments, it is observed that internal Cooperative Intelligent Transport System (C-ITS) infrastructure data are linked with external C-ITS clouds based on interchange nodes.

An interchange provides real-time data exchange and high scalability between different back-end systems, and the interchange operates through multiple message brokers. Through the message brokers, it is possible to collect, analyze, and process message data from different service providers, and the interchange may be implemented in both the private and public sectors. Each interchange tracks all available datasets from connected service providers and stores metadata regarding the datasets, whereby information on all available datasets is shared among all interchanges.

A method of processing/refining message data collected by ITS central systems or interchanges may vary depending on various purposes and conditions, such as service objectives, standardized formats, and channel capacity statuses. To preserve original information included in the message data, the collected message data may be retransmitted without modification. However, as in the example of CPM standard requirements, multiple received messages may be analyzed, processed, aggregated, and transmitted in a sensor data sharing message format (e.g., CPM). The sensor data sharing message format is structurally designed to comprehensively contain key information of messages among different heterogeneous types (e.g., vehicle, VRU, animal, obstacle, etc.). Therefore, when integration of formats is required, the use of the sensor data sharing message format may be considered. In addition to the CPM, the SDSM may also be used as another sensor data sharing message format.

### Sharing of Path-History/Path-Prediction Information

FIG. 4 illustrates examples of various message conversions using a sensor data sharing message format.

Path prediction/history information may be transmitted in a V2X message format (e.g., BSM, CAM, PSM, VAM, etc.). However, since the sensor data sharing message format is designed to integrate messages among heterogeneous types (e.g., vehicle, VRU, animal, obstacle) into a single format, it may be desirable that path-prediction/history information be provided in the sensor data sharing message format for the convenience of compatibility, such as format integration among service stakeholders or version management and operation issues of respective messages.

Currently, the CPM, which is one of the sensor data sharing message formats, supports transmitting aggregated messages. However, according to the current CPM standard, a data field for containing path-history and path-prediction information of V2X messages (e.g., BSM, CAM, PSM, VAM, etc.) transmitted by vehicles or VRUs has not been defined in the CPM.

The present disclosure relates to a method of sharing path-history and path-prediction information of V2X messages (e.g., BSM, CAM, PSM, VAM) transmitted for awareness purposes by vehicles or VRUs and received by a server (or RSU/UE) based on currently defined sensor data sharing message formats.

The present disclosure also provides a method of providing path-history and path-prediction information together when sensor data sharing V2X messages such as a CPM, SDSM, and Surrogate Basic Safety Message (SBSM) are directly generated by a server (or RSU/UE) in addition to awareness-purpose V2X messages such as a BSM, CAM, PSM, and VAM.

As another example of using a sensor data sharing message format, the SDSM may be used in addition to the CPM.

The server (or RSU/UE) may classify awareness messages (e.g., BSM, CAM, PSM, VAM) through data parsing processing based on certain conditions. The server (or RSU/UE) may check whether path-history and path-prediction information and key field values required for conversion into the sensor data sharing message format are included in awareness messages (e.g., BSM, CAM, PSM, VAM) arranged according to certain criteria. Then, the server (or RSU/UE) may designate/determine messages to be converted.

If necessary, when directly generating sensor data sharing messages such as a CPM, SDSM, or SBSM, the server (or RSU/UE) may also designate/determine target messages that require conversion into the sensor data sharing V2X message format.

When the designation of target message(s) to be converted is completed, before conversion into the sensor data sharing message format, the server (or RSU/UE) may notify the target object of information on the target message for conversion that the information thereof will be converted into the sensor data sharing message format generated by the server/RSU/UE and then propagated to other V2× objects.

The server (or RSU/UE) may parse the designated specific message(s), configure mandatory fields using the sensor data sharing message format, and represent information at multiple time points (path-prediction/history) for a single UE as multiple object lists. In this case, data conversion/processing operations for representing path-prediction/history in the sensor data sharing message format may be performed differently depending on the message designation state.

When multiple designated messages including path-prediction/path-history information are converted, the server (or RSU/UE) may reference path-prediction/path-history information included in multiple pieces of information within a certain time duration and then calculate or correct the information through Artificial Intelligence/Machine Learning (AI/ML).

Accordingly, compared to the existing path-history/prediction information, the accuracy of path-history/prediction information may be improved and the number of transmission data may become more efficient, and the information may be included in the sensor data sharing message format.

When a single sensor data sharing message includes both object information detected by a sensor and information acquired from a message received by an ITS station generating the sensor data sharing message, it may be necessary to provide a method of distinguishing between an object detected by the sensor and an object for which data fields need to be filled with information acquired from the received message, from the perspective of the V2X message exchange function.

### (A) Sorting/Classification of Collected Awareness V2X Messages

Path-history and path-prediction information may respectively relate to a past movement path and a future predicted path of an object (e.g., a vehicle or a VRU) that transmits the information. Such information is mainly included in various heterogeneous V2X messages (e.g., SAE-BSM, PSM, ETSI-CAM, VAM, etc.) for sharing awareness information of moving objects supporting V2X communication with surrounding entities. The corresponding information fields or container data frames including the fields are generally managed as optional attributes, and the information may be selectively included from the message transmitting system.

Another characteristic of awareness V2X messages mainly including path-history and path-prediction information is that the messages are transmitted at specific time intervals. Accordingly, when the corresponding information is collected by the server (or RSU/UE), multiple messages transmitted from the same object may be accumulated in chronological order.

To convert into the sensor data sharing message format, the server classifies message data by arranging such messages based on specific conditions. In addition, when the validity of data information (e.g., real-time property) is determined to be low, the corresponding data may be deleted so as to secure server computing resources.

As one example of sorting/classification conditions for awareness-purpose V2X messages that may include path-history and path-prediction information, a method may be considered in which (1) the messages are sorted in order of transmitting objects, and (2) for the same transmitting object, the messages are sorted in chronological order of transmission time.

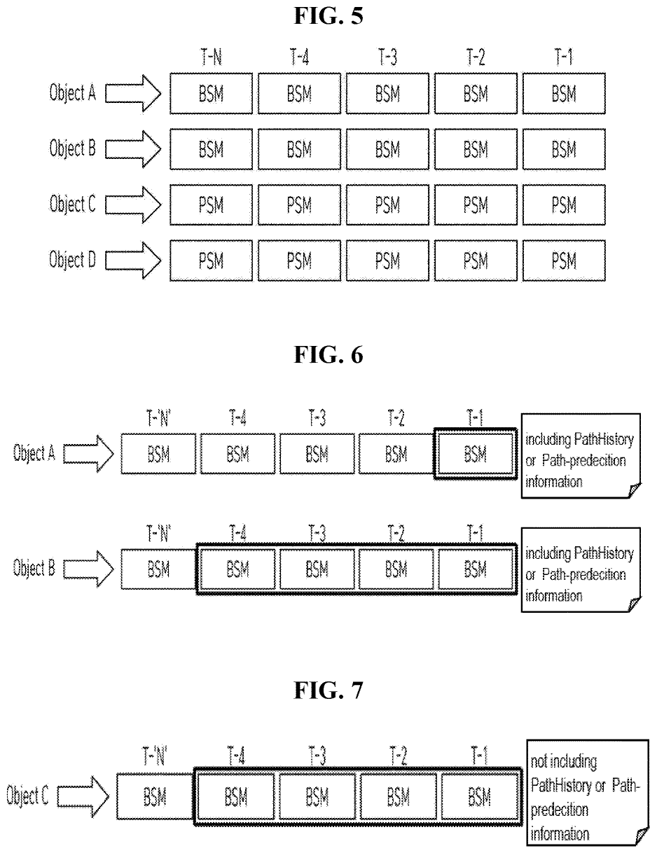

FIG. 5 illustrates an example of message sorting. In FIG. 5, the targets of information included in each message and the transmitting entities are the same. For example, the BSM at the top is information of object A, and the BSM is transmitted by object A.

### (B) Designation of Sorted/Classified Target Message(s) for Conversion

Although conditions for determining a target message may vary, basically, when path-history and path-prediction information is included and essential basic information for generating the sensor data sharing message format exists within a message, the message may be designated as the target message for conversion/restructuring. If such essential basic information data does not exist, the message may not be designated as the target message for conversion. Even if the message is designated, proper conversion may not be possible.

The server (or RSU/UE) designates the target message for conversion after determining, through parsing, whether the classified awareness messages (e.g., BSM, CAM, PSM, VAM) include path-history and path-prediction information and are eligible for transmission in the sensor data sharing message format.

If necessary, when directly generating a sensor data sharing message such as a CPM, SDSM, or SBSM, the server (or RSU/UE) may also designate the target message that require conversion into the sensor data sharing V2X message format.

Table 1 shows data information attributes and examples in awareness V2X messages essential for the sensor data sharing message format, through parsing by the server (or RSU/UE). In addition to the items listed in Table 1, all information data items of awareness messages required for inclusion in the sensor data sharing message format may be included in the verification items.

TABLE 1
1. Fields related to information on origination system of data transmission and
examples of major messages
(1) PSM
PersonalDeviceUserType
(2) CAM, VAM
StationType
2. Fields related to detailed object information and examples of major messages
(1) Information related to positioning
i) BSM/PSM
Latitude, Longitude, Elevation, PositionalAccuracy
... /PathHistory/FullPositionVector
ii) CAM, VAM
referencePosition
(2) Information data generation time
i) BSM/PSM
DDateTime
ii) CAM/VAM
generationDeltaTime
(3) Fields related to speed and acceleration information and examples of major messages
i) BSM/PSM
Speed, AccelerationSet4Way
ii) CAM/VAM
Speed, longitudinalAcceleration
(4) Fields related to direction information and examples of major messages
i) BSM/PSM/CAM/VAM
Heading, SteeringWheelAngle
(5) Fields related to size information and examples of major messages
i) BSM
VehicleSize
ii) CAM
VehicleLength, VehicleWidth
(6) Fields related to PathHistory information and examples of major messages
i) BSM
BSMpartIIExtension / VehicleSafetyExtensions / PathHistory / PathHistoryPointList
/ ... ...
ii) PSM
PathHistory / PathHistoryPointList
iii) CAM
CoopAwareness / CamParameters / LowFrequencyContainer /
BasicVehicleContainerLowFrequency / PathHistory
iv) VAM
vruMotionPredictionContainer / pathHistory
(7) Fields related to PathPrediction information and examples of major messages
i) BSM
BSMpartIIExtension / VehicleSafetyExtensions / PathPrediction / RadiusOfCurvature
/ ... ...
ii) PSM
PathPrediction / RadiusOfCurvature
iii) CAM
※ No relevant information currently available
iv) VAM
vruMotionPredictionContainer / pathPrediction

Various criteria and conditions may be applied for designating messages depending on different situations, such as the type of service and whether specific information data is included in collected messages. For example, target messages for conversion may be designated as follows according to the inclusion status of major data.

(1) Among the collected messages, when both essential information data for the sensor data sharing message format and path-history and path-prediction information data are included, the most recent one message including the information data or N messages included at a specific time/duration may be designated. FIG. 6 illustrates an example in which a message including path-history and path-prediction information is designated as the target message for conversion.

(2) Among the collected messages, in the case of a message including essential information data for the sensor data sharing message format but not including path-history or path-prediction information data, multiple specific messages may be designated to sequentially or periodically select and aggregate such messages, depending on determination by the server (or RSU/UE) or for implementation of service requirements using the path-history or path-prediction information. FIG. 6 illustrates an example in which a message not including path-history and path-prediction information is designated as the target message for conversion.

(3) To reduce the delay incurred in analyzing and transmitting received messages, when the server (or RSU/UE) directly generates the sensor data sharing message, both object information detected by a sensor and a message received by an ITS station designated in a manner similar to the above may be included together in the sensor data sharing message.

When designation of target message(s) for conversion is completed, before conversion into the sensor data sharing message format, the server (or RSU/UE) may notify the target object of information on the target message for conversion that the information thereof will be converted into the sensor data sharing message format generated by the server/RSU/UE and propagated to other V2× objects. Depending on the purpose of the service or the operation method/policy, the transmission of such information may have various options such as unilateral transmission or proceeding to the next step after requesting consent.

The above operation may be particularly necessary when a message generated by converting information into the sensor data sharing message format at the server/RSU/UE is transmitted by broadcast/groupcast.

For example, when the server/RSU/UE transmits a message generated by converting information into the sensor data sharing message format (through network communication via unicast) to UE A (located in or traveling within a specific area), the server/RSU/UE may generate and transmit the sensor data sharing message (generated as described above) without including information of UE A as object information in the message (for message size reduction). Therefore, it may not be necessary for the server/RSU/UE to separately notify whether the information of UE A is included in the message generated by converting the information into the sensor data sharing message format.

For example, when the server/RSU/UE transmits a message generated by converting information into the sensor data sharing message format (through network communication via unicast) to UE A (located in or traveling within a specific area), if information of UE A is included as object information in the sensor data sharing message (generated as described above), the server/RSU/UE may transmit, together with or separately from the sensor data sharing message, a notification message to UE A indicating that information of UE A is included in the message. Examples of the content of the notification message indicating that information of UE A is included in the message will be separately described below.

For example, when the server/RSU/UE transmits a message generated by converting information into the sensor data sharing message format (through network communication via unicast) to UE A (located in or traveling within a specific area), information indicating that the message includes information of UE A may be transmitted by being included in the sensor data sharing message (or as a separate message). Examples of the content of the notification message indicating that information of UE A is included in the message will be separately described below.

Examples of information that may be included to notify that information of UE A is included in the message generated by the server/RSU/UE through conversion into the sensor data sharing message format:
ID(s) of the corresponding object included in the message
An ID used by the corresponding object when transmitting a message generated by the object (e.g., a station ID included in the most recent message received by the server/RSU/UE from the object)
An ID of the message transmitted by the server/RSU/UE in which information of UE A is included as object information, a station ID included in the message, a message generation/transmission time (e.g., message generation time), and/or the number of objects included in the message (e.g., the number of objects detected by a sensor, and/or the number of UEs converted into the object form by the server/RSU/UE based on received messages, and/or a sum thereof)

Upon recognizing that information of UE A is included in the sensor data sharing message transmitted from the server/RSU/UE, UE A may omit/simplify reception-related operations, or may not decode the corresponding sensor data sharing message. Alternatively, after decoding the message, UE A may accurately distinguish whether the object information in the message is for UE A or another UE in proximity, which may be used to reduce the occurrence frequency/probability of false alarms and/or miss detections in use cases such as collision warning and VRU/vehicle awareness.

Meanwhile, even if the server/RSU/UE does not separately notify a specific UE (=UE A) that information of UE A is included in the message generated by converting information into the sensor data sharing message format, if the sensor data sharing message received by UE A from the server/RSU/another UE includes object information that matches path-history/prediction information previously transmitted by UE A in a message to the corresponding server/RSU/another UE at or above a certain level (and/or when the number of path points related to path-history/prediction is equal to or greater than a specific number), UE A may determine that the object is highly likely to be UE A, may omit collision/risk assessment analysis/calculation operations with the corresponding object, may not display a collision warning with the corresponding object on the UE, and/or may process the collision warning with lower priority (compared to analysis/calculation operations with other objects) (particularly in situations where the collision/risk assessment analysis/calculation capability of the UE is limited)

(C) Conversion of Data of Designated Target Message(s) into Sensor Data Sharing Message Format

The server (or RSU/UE) parses target message(s) for conversion and converts and inputs the target message(s) as the content of mandatory fields of the sensor data sharing message format. Table 2 shows examples of major essential data information attributes and fields for the sensor data sharing message format. In addition to the items in Table 2, mandatory field items to be included in the sensor data sharing message format may be changed/added depending on the type of sensor data sharing message.

The process of converting and inputting message(s) as the contents of the mandatory fields of the sensor data sharing message format should be performed by determining and inputting values that are identical to the contents of essential information included in the target message for conversion, or values capable of being most closely matched within the range of the same attribute information.

TABLE 2
1. Example of conversion with reference to information on origination system of data
transmission
(1) Target message for conversion → CPM
CollectivePerceptionMessage/ CpmParameters/ CpmManagementContainer/
StationType ::= INTEGER {unknown(0), pedestrian(1), cyclist(2), moped(3),
motorcycle(4), passengerCar(5), bus(6), lightTruck(7), heavyTruck(8),
trailer(9), specialVehicles(10), tram(11), roadSideUnit(15)} (0..255)
- When the target message for conversion is a CAM or VAM, an identical value selected
from among the above selection values is input by referencing StationType information
included in the message.
- When the target message for conversion is a BSM, a value most similar to the above
selection value is input by referencing SupplementalVehicleExtensions/BasicVehicleClass
information. If BasicVehicleClass information is not available, the value may be input as
passengerCar(5).
- When the target message for conversion is a PSM, a value most similar to the above
selection value is input by referencing PersonalDeviceUserType information.
(2) Target message for conversion → SDSM
EquipmentType = unknown (0), rsu (1), obu (2), vru (3)
- When the target message for conversion is a CAM or VAM, a value most similar to the
above selection value is input by referencing StationType information included in the
message.
- When the target message for conversion is a BSM, a value most similar to the above
selection value is input by referencing SupplementalVehicleExtensions/BasicVehicleClass
information. If BasicVehicleClass information is not available, the value may be input as
vru (3).
- When the target message for conversion is a PSM, a value most similar to the above
selection value is input by referencing PersonalDeviceUserType information.
2. Example of conversion with reference to detailed station information - message
generation time
(1) Target message for conversion → CPM
generationDeltaTime ::= INTEGER { oneMilliSec(1) } (0..65535)
- When the target message for conversion is a CAM or VAM, an identical value is input by
generationDeltaTime information included in the message.
- When the target message for conversion is a BSM or PSM, an identical value is input by
referencing DSecond information included in the message.
(2) Target message for conversion → SDSM
MsgTimeStamp/DDay = INTEGER (0..31) -- units of days
MsgTimeStamp/DTime/DHour = INTEGER (0..31) -- units of hours
MsgTimeStamp/DTime/DMinute = INTEGER (0..60) -- units of minutes
MsgTimeStamp/DTime/ DSecond = INTEGER (0..65535) -- units of milliseconds
- Regardless of the type of target message for conversion, a value corresponding to the time
at which the message is received is input by referencing log recording time information of
the server (or RSU/UE).
3. Example of conversion with reference to reference position information
(1) Target message for conversion → CPM
ReferencePosition/ Latitude, Longitude, positionConfidenceEllipse, altitude
- When the target message for conversion is a CAM or VAM, an identical value selected
from among the above selection values is input by referencing referencePosition
information included in the message.
- When the target message for conversion is a BSM or PSM, a value most similar to the
above selection values is input by referencing .../PathHistory/FullPositionVector
information.
(2) Target message for conversion → SDSM
Position3D/Latitude, Longitude, Elevation(Optional), PositionalAccuracy
- When the target message for conversion is a CAM or VAM, a value most similar to the
above selection values is input by referencing referencePosition information included in
the message.
- When the target message for conversion is a BSM or PSM, a value most similar to the
above selection values is input by referencing .../PathHistory/FullPositionVector
information.
4. Example of conversion with reference to the number of sensing objects list
(1) Target message for conversion → CPM
CollectivePerceptionMessage/ CpmParameters/ NumberOfPerceivedObjects
- Regardless of the type of target message for conversion, if the target object of path-
history and prediction information to be included in one sensor data sharing message
format is one, the value is input as 1.
- When the target message is included in the sensor data sharing V2X message directly
generated by the server (or RSU/UE), the object information detected by a sensor and the
number of objects acquired from a message received by an ITS station designated in a
similar manner to the above may be input.

After parsing the target message(s) for conversion, the server (or RSU/UE) converts information at multiple time points (path-prediction/history) for a single UE into multiple object lists for input. In this case, the data conversion method may vary depending on the message designation state.

### (1) Example of Conversion of Single Designated Message Including Path-Prediction or Path-History Information

For example, it is assumed that information on the target message for conversion includes path-prediction or path-history information at the most recent or a specific time point for a single UE.

### 1) Path History Information

### (i) Target Message for Conversion→CPM

PerceivedObjectContainer/PerceivedObject/objectID, TimeOfMeasurement, xDistance, yDistance
   When the target message for conversion is a BSM or PSM, the data element values of PerceivedObject are input by referencing . . . /PathHistory/PathHistory PointList::=SEQUENCE (SIZE(1 . . . 23)) OF PathHistoryPoint information included in the message.
   When the target message for conversion is a CAM or VAM, the data element values of PerceivedObject are input by referencing PathHistory::=SEQUENCE (SIZE(0 . . . 40)) OF PathPoint information included in the message.

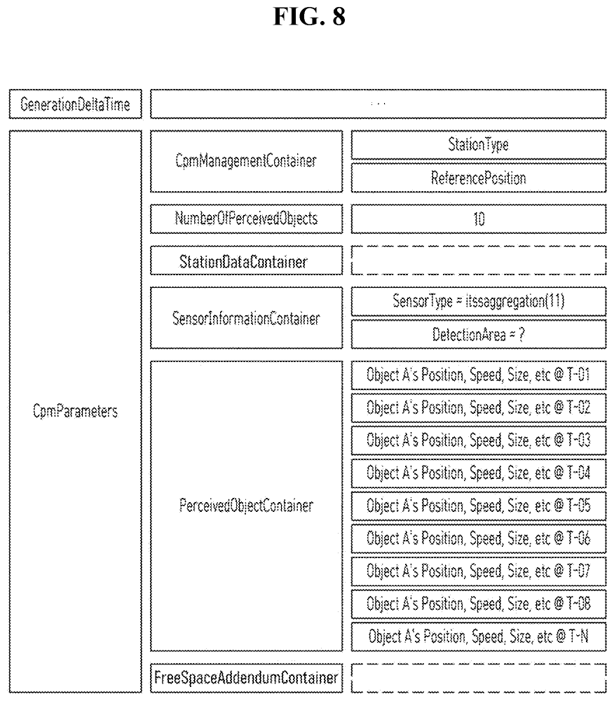

FIG. 8 illustrates an example in which a target message for conversion is converted into a CPM to provide path-history. Referring to FIG. 8, PerceivedObjectContainer provides information on the position, speed, and size of Object A at multiple different (past) time points T-01 to T-N. StationDataContainer and FreeSpaceAddendumContainer are optional data containers provided when the target message for conversion is converted into a CPM defined in the ETSI standard. StationDataContainer and FreeSpaceAddendumContainer may be omitted in the CPM depending on the embodiment. Meanwhile, a data container is a higher-level data bundle that groups detailed data having similar attributes.

Meanwhile, StationDataContainer and FreeSpaceAddendumContainer (or corresponding information) may be provided not only when the target message for conversion is converted into a CPM defined in the ETSI standard, but also when the target message for conversion is converted into an SDSM defined in the SAE standard.

### (ii) Target Message for Conversion→SDSM

DetectedObjectList/DetectedObjectData/DetectedObjectCommonData/ObjectType, ObjectID, MeasurementTimeOffset, PositionOffsetX, PositionOffsetY, Heading
   When the target message for conversion is a BSM or PSM, the data element values of DetectedObjectData are input by referencing . . . /PathHistory/PathHistoryPointList::=SEQUENCE (SIZE(1 . . . 23)) OF PathHistoryPoint information included in the message.
   When the target message for conversion is a CAM or VAM, the data element values of DetectedObjectData are input by referencing PathHistory::=SEQUENCE (SIZE(0 . . . 40)) OF PathPoint information included in the message.
      (iii) Common Requirements

By referencing positioning information of path points included in the PathHistoryPoint or PathPoint data frame related to the path-history of the corresponding message, UE objects corresponding to the number of pieces of point information and the path point positioning information for each object may be converted and included in each sensing object-related data frame.

Data to be represented as time or distance offsets indicates difference values compared with the data frame referenced from the reference position information.

Basically, to indicate that object information at multiple time points corresponds to the same object, the same object ID value may be used. However, for the purpose of reducing message size, it may be considered that elements such as object ID or size, which do not change over time, are not included in all object information.

Confidence information refers to the confidence level of path-history/prediction. This information may be considered to be included by referencing the confidence level and related information included in the target message for conversion. When it is determined by the server (or RSU/UE) that the accuracy of path-history/prediction information included in the target message for conversion is low or the information does not exist, the server (or RSU/UE) may directly perform a function of improving the accuracy of the path-history/prediction information. In addition, when it is confirmed that the confidence level and related information is improved compared to the existing information, an improved confidence level value may be indicated.

### 2) Path-Prediction Information

### (i) Target Message for Conversion→CPM

PerceivedObjectContainer/PerceivedObject/objectID, TimeOfMeasurement, xDistance, yDistance
   When the target message for conversion is a BSM or PSM, the data element values of PerceivedObject are input by referencing . . . /PathPrediction/RadiusOfCurvature::=INTEGER (−32767 . . . 32767) information included in the message.

Since the information only represents curvature information, the server (or RSU/UE) should be able to predict positioning point information of a future path to be referenced and generate positioning point information up to a certain timing duration by analyzing information such as the current speed, direction, and trajectory of the object. Based on the information and the number thereof, the information is converted into each sensing object-related data frame of a single UE object.

When the target message for conversion is a VAM, the data element values of PerceivedObject are input by referencing SequenceOfVruPathPoint/VruPathPoint/ReferencePosition and PathDeltaTime information included in the message.
By referencing positioning information of path points included in the VRUPathPoint data frame related to future path points of the corresponding message, UE objects corresponding to the number of pieces of point information and the path point positioning information for each object may be converted and included in each sensing object-related data frame.

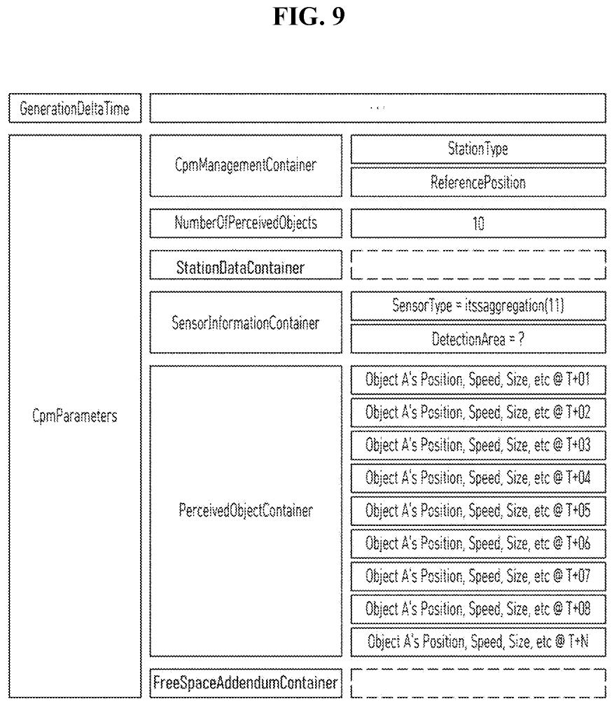

FIG. 9 illustrates an example in which a target message for conversion is converted into a CPM to provide path-prediction information. Referring to FIG. 9, PerceivedObjectContainer provides information on the position, speed, and size of Object A at multiple different (future) time points T+01 to T+N. StationDataContainer and FreeSpaceAddendumContainer are optional data containers provided when the target message for conversion is converted into a CPM defined in the ETSI standard. StationDataContainer and FreeSpaceAddendumContainer may be omitted from the CPM depending on the embodiment. Meanwhile, a data container is a higher-level data bundle that groups detailed data having similar attributes.

Meanwhile, StationDataContainer and FreeSpaceAddendumContainer (or corresponding information) may be provided not only when the target message for conversion is converted into a CPM defined in the ETSI standard, but also when the target message for conversion is converted into an SDSM defined in the SAE standard.

### (ii) Target Message for Conversion→SDSM

DetectedObjectList/DetectedObjectData/DetectedObjectCommonData/ObjectType, ObjectID, MeasurementTimeOffset, PositionOffsetX, PositionOffsetY, Heading
   When the target message for conversion is a BSM or PSM, the data element values of DetectedObjectData are input by referencing . . . /PathPrediction/RadiusOfCurvature::=INTEGER (−32767 . . . 32767) information included in the message.

Since the information only represents curvature information, the server (or RSU/UE) should be able to predict positioning point information of a future path to be referenced and generate positioning point information up to a certain timing duration by analyzing information such as the current speed, direction, and trajectory of the object. Based on this information and the number thereof, the information is converted into each sensing object-related data frame of a single UE object.
When the target message for conversion is a VAM, the data element values of DetectedObjectData are input by referencing SequenceOfVruPathPoint/VruPathPoint/ReferencePosition and PathDelta Time information included in the message.

By referencing positioning information of path points included in the VRUPathPoint data frame related to future path points of the corresponding message, UE objects corresponding to the number of pieces of point information and the path point positioning information for each object may be converted and included in each sensing object-related data frame.

(iii) Common Requirements

Data to be represented as time or distance offsets indicates difference values compared with the data frame referenced from the reference position information.

Basically, to indicate that object information at multiple time points corresponds to the same object, the same object ID value may be used. However, for the purpose of reducing message size, it may be considered that elements such as object ID or size, which do not change over time, are not included in all object information.

Confidence information refers to the confidence level of path-history/prediction. This information may be considered to be included by referencing the confidence level and related information included in the target message for conversion. When it is determined by the server (or RSU/UE) that the accuracy of path-history/prediction information included in the target message for conversion is low or the information does not exist, the server (or RSU/UE) may directly perform a function of improving the accuracy of the path-history/prediction information. In addition, when it is confirmed that the confidence level and related information is improved compared to the existing information, an improved confidence level value may be indicated.

### (2) Example of Conversion of N Designated Messages Including Path-Prediction or Path-History Information

Target messages for conversion may include path-prediction or path-history information of a single UE for multiple durations/time points.

After parsing target messages for conversion, the server (or RSU/UE) converts information at multiple time points (path-prediction/history) for a single UE into multiple object lists. In this case, the data conversion method may vary depending on the message designation state. This method may be similar to the conversion of a single designated message described above in (1).

However, unlike the example of converting a single designated message described above in (1), in the example of converting N designated messages to be described in (2), the server (or RSU/UE) may reference path-prediction/path-history information contained in multiple pieces of information during a certain time duration and then calculate/correct the information through AI/ML. Accordingly, compared to the existing path-history/prediction information, the accuracy of path-history/prediction information may be improved and the number of transmission data may become more efficient, and the information may be included in the sensor data sharing message format.

For example, in the example of converting a single designated message described above in (1), the number of pieces of PathPoint information should be the same as the number of object lists to be included in the sensor data sharing message format. However, in the example of converting N designated messages to be described in (2), the number of objects to be included may be reduced, if necessary, through calculation/correction processing by the server.

As another example, the server (or RSU/UE) may detect whether errors exist in position information included in the target message for conversion and correct the errors. The server (or RSU/UE) may indicate corrected values in fields related to path-history and path-prediction.

### (3) Example of Conversion of Multiple Designated Messages not Including Path-Prediction or Path-History Information

### 1) Path History Information

### (i) Target Message for Conversion→CPM

PerceivedObjectContainer/PerceivedObject/objectID, TimeOfMeasurement, xDistance, yDistance

### (ii) Target Message for Conversion→SDSM

DetectedObjectList/DetectedObjectData/DetectedObjectCommonData/ObjectType, ObjectID, MeasurementTimeOffset, PositionOffsetX, PositionOffsetY, Heading
   (iii) Common Requirements

In the case of such designated messages, reference data fields related to PathHistory do not exist as shown below.
BSM, PSM: . . . /PathHistory/PathHistoryPointList::=SEQUENCE (SIZE(1 . . . 23)) OF PathHistoryPoint
CAM, VAM: PathHistory::=SEQUENCE (SIZE(0 . . . 40)) OF PathPoint

Therefore, instead of the number of path points of path-history positioning information of the message, UE objects corresponding to the number of designated messages and the positioning information of each object may be converted and included in each sensing object-related data frame.

By referencing positioning, information data generation time, speed and acceleration, and direction information included in each of the target messages for conversion, the data element values of PerceivedObject and DetectedObjectData are input.

Since PathHistory does not exist, a similar field value is input in the reference position information of the sensor data sharing message format, by referencing the positioning information of the first message among multiple target messages for conversion.

Data to be represented as time or distance offsets indicates difference values compared with the data frame referenced from the reference position information.

Basically, to indicate that object information at multiple time points corresponds to the same object, the same object ID value may be used. However, for the purpose of reducing message size, it may be considered that elements such as object ID or size, which do not change over time, are not included in all object information.

Confidence information refers to the confidence level of path-history/prediction. This information may be considered to be included by referencing the confidence level and related information included in the target message for conversion. When it is determined by the server (or RSU/UE) that the accuracy of path-history/prediction information included in the target message for conversion is low or the information does not exist, the server (or RSU/UE) may directly perform a function of improving the accuracy of the path-history/prediction information. In addition, when it is confirmed that the confidence level and related information is improved compared to the existing information, an improved confidence level value may be indicated.

### 2) Path-Prediction Information

### (i) Target Message for Conversion→CPM

PerceivedObjectContainer/PerceivedObject/objectID, TimeOfMeasurement, xDistance, yDistance

### (ii) Target Message for Conversion→SDSM

DetectedObjectList/DetectedObjectData/DetectedObjectCommonData/ObjectType, ObjectID, MeasurementTimeOffset, PositionOffsetX, PositionOffsetY, Heading
   (iii) Common Requirements

In the case of such designated messages, reference data fields related to PathPrediction do not exist as shown below.
BSM, PSM→ . . . /PathPrediction/RadiusOfCurvature::=INTEGER (−32767 . . . 32767)
VAM→SequenceOfVruPathPoint/VruPathPoint/ReferencePosition, PathDeltaTime

Therefore, the server (or RSU/UE) should be able to generate positioning point information up to a certain timing duration predicted by analyzing UE objects corresponding to the number of designated messages and the positioning information, speed information, and direction information of each object. Based on this information and the number thereof, the information is converted into each sensing object-related data frame of a single UE object.

By referencing positioning, information data generation time, speed and acceleration, and direction information included in each of the target messages for conversion, positioning points up to a certain future time point based on analysis results of the server (or RSU/UE) are reflected, and the data element values of PerceivedObject and DetectedObjectData are input. For example, when the number of designated messages is 10, there may be only three object positioning points up to a certain future time point analyzed from these messages.

Data to be represented as time or distance offsets indicates difference values compared with the data frame referenced from the reference position information.

Basically, to indicate that object information at multiple time points corresponds to the same object, the same object ID value may be used. However, for the purpose of reducing message size, it may be considered that elements such as object ID or size, which do not change over time, are not included in all object information.

Confidence information refers to the confidence level of path-history/prediction. This information may be considered to be included by referencing the confidence level and related information included in the target message for conversion. When it is determined by the server (or RSU/UE) that the accuracy of path-history/prediction information included in the target message for conversion is low or the information does not exist, the server (or RSU/UE) may directly perform a function of improving the accuracy of the path-history/prediction information. In addition, when it is confirmed that the confidence level and related information is improved compared to the existing information, an improved confidence level value may be indicated.

(4) When Designated Message(s) Similar to Above Examples are Included Together with Sensor-Detected Object Information in Sensor Data Sharing Message Directly Generated by Server (or RSU/UE)

When it is necessary to reduce latency incurred in analyzing received messages and retransmitting the message to UEs, if the server (or RSU/UE) generates a single sensor data sharing message, there may be cases where it is advantageous to include both sensor-detected object information and information acquired from the received messages together.

Case (4) may include the following forms: (1) single designated message and (2) N designated messages described above.

In this case, it may be necessary to distinguish, within a message, between objects detected by a sensor and objects for which data fields need to be filled with information acquired from received messages. The reasons why it may be necessary to distinguish, within a message, between objects detected by a sensor and objects for which data fields need to be filled with information acquired from received messages are as follows.
In the case of an object for which data fields need to be filled with information acquired from received messages, it may be necessary that the receiving UE also recognize that information included in a sensor information data container is not valid.
The definition of a confidence level for information on a detected object may differ from the definition of a confidence level for object-related information for which data fields need to be filled with information acquired from received messages.

Examples of main methods for distinguishing such information are as follows.
A method may be considered in which a set of object IDs assigned to objects detected by a sensor and a set of object IDs assignable to objects for which data fields need to be filled with information acquired from received messages are used such that the sets of object IDs do not overlap with each other.
Similar to NumberOfPerceivedObjects in a CPM, when a single sensor data sharing message includes both object information detected by a sensor and information acquired from messages received by the ITS station generating the sensor data sharing message, it may also be possible to include in the message a data element indicating the number of detected objects and a data element indicating the number of objects for which data fields are filled with information acquired from received messages.
An operation in which the server/RSU according to the present disclosure fuses multiple types of messages to generate a new type of information/category may be regarded as a new service provided by the server/RSU. When a sensor data sharing message is generated, a <sensor data sharing message including only object information obtained from general sensor data> and a <sensor data sharing message generated based on message aggregation> use the same format, but the messages may appear as different messages/services. Instead of including the messages together in a single format, it may also be possible to use different message IDs such that the receiving UE distinguishes between the two types of messages by the message IDs.

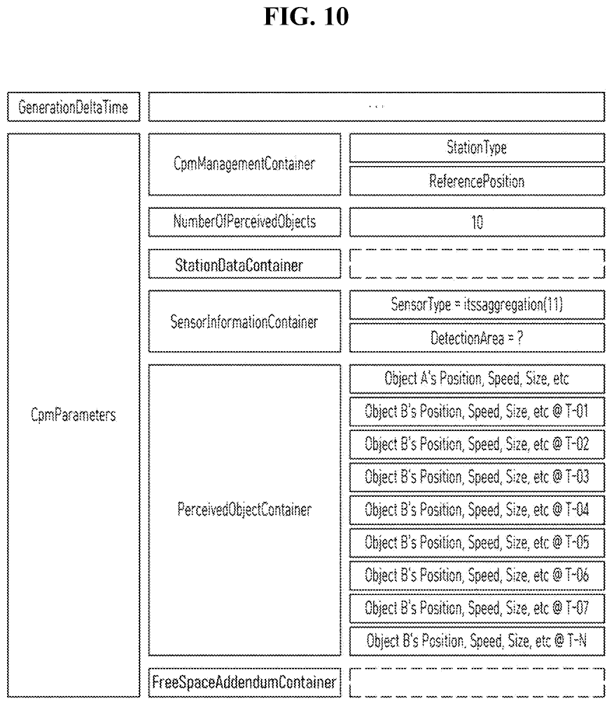

FIG. 10 illustrates an example of CPM path-history representation. In the CPM of FIG. 10, both a sensor-detected object message and designated target messages for conversion are included together. Referring to FIG. 10, PerceivedObjectContainer provides information on the position, speed, and size of object A at multiple different (past) time points T-01 to T-N. In addition, SensorInformationContainer provides information (e.g., detection area, sensor type) directly sensed by the server (or RSU/UE) with respect to object A (and/or another object). StationDataContainer and FreeSpaceAddendumContainer are optional data containers provided when a target message for conversion is converted into a CPM defined in the ETSI standard, and StationDataContainer and FreeSpaceAddendumContainer may be omitted from the CPM depending on the embodiment. Meanwhile, a data container is a higher-level data bundle that groups detailed data having similar attributes.

Meanwhile, StationDataContainer and FreeSpaceAddendumContainer (or corresponding information) may be provided not only when the target message for conversion is converted into a CPM defined in the ETSI standard, but also when the target message for conversion is converted into an SDSM defined in the SAE standard.

For example, when ITS stations of various business domains exchange V2X messages in various message formats for V2N2X-based ITS services, such entities are linked with a cloud server domain, and message data is interconnected through an interchange function (or a message/information broker).

When using a sensor data sharing message format that comprehensively covers various types of information for interoperability between entities and convenience of data maintainability in such a data interconnection process, the methods proposed in the present disclosure may be applied to generate a message including path-history and path-prediction information of a specific object, which did not previously exist.

In addition, a message including both a converted message and a sensor-detected object message may also be generated.

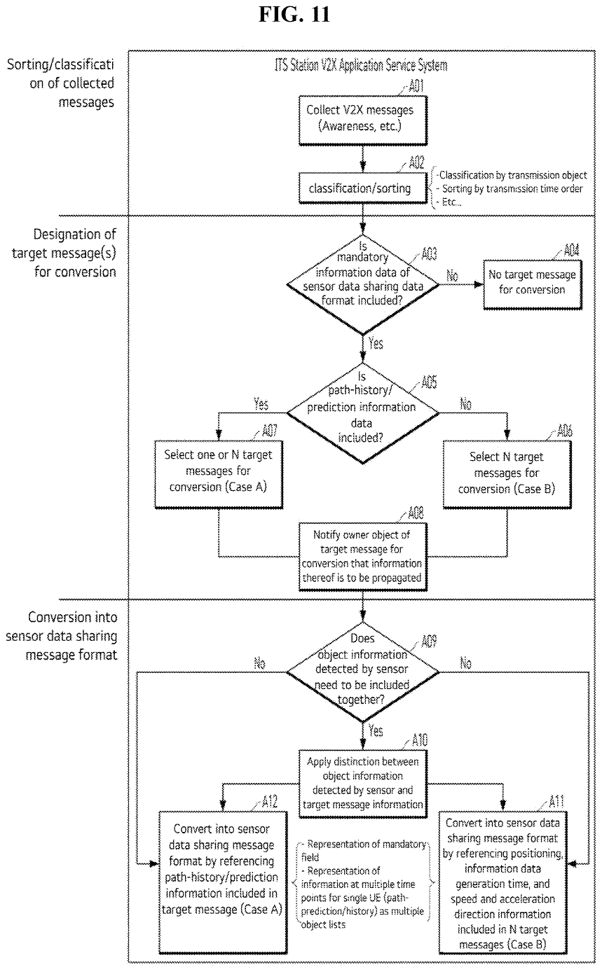

FIG. 11 is a diagram for explaining a data processing procedure for providing path-history/prediction information.

Referring to FIG. 11, a device (e.g., server/RSU/UE) may receive/collect V2X messages from other devices (A01). The device may classify/sort the received/collected V2X messages (A02). For example, the V2X messages may be sorted based on transmitting object and/or transmission time order.

The device may check whether each V2X message includes essential data required for a sensor data sharing message format (A03). The device may exclude V2X messages not including the essential data from conversion (A04).

The device may check whether the path-history/prediction information is included in each V2X message (A05). When the path-history/prediction information is not included, the device designates N V2X messages as target messages for conversion (A06). When the path-history/prediction information is included, the device designates one or N V2X messages as target messages for conversion (A07).

The device may notify the target (owner) object of a target message for conversion that the information of the target (owner) object is to be propagated (A08).

The device may determine whether to include sensor-detected object information together with the target message for conversion in the sensor data sharing message format (A09). When the sensor-detected object information and the target message for conversion are included together in the sensor data sharing message format, the device may include information for distinguishing whether the data is the sensor-detected object information or the target message for conversion in the sensor data sharing message format (A10).

When the path-history/prediction information is included in the target message for conversion, the device may generate the sensor data sharing message format based on the path-history/prediction information of the target message for conversion (A12).

When the path-history/prediction information is not included in the target message for conversion, the device may generate the sensor data sharing message format based on other information included in the target message for conversion, for example, positioning information, data generation time information, speed information, acceleration information, and direction information (A11).

### Sharing of Aggregation Information

For a sensor data sharing service, a vehicle or RSU/server equipped with sensors thereof (radar, LiDAR, infrared, camera, fusion data, etc.) may fail to obtain sensor object information at a specific location and time within the coverage of the mounted sensors due to various and unexpected reasons such as shadow areas, interference, or sensor malfunctions. In addition, the acquisition of the sensor object information may also fail due to object locations outside the maximum coverage range of the mounted sensors.

In this case, if the sensor object information that is essential for the purpose of a specific service is not included in the sensor data sharing message format, the quality of the service may be degraded. If the requirements related to the coverage of sensor detection areas for a service with a specific purpose are expanded or changed, modification of the system design for supporting the service may be required.

Hereinafter, a method will be described in which a server (or RSU/UE) analyzes objects detected within the coverage of sensors mounted therein and received V2X messages and represents both the detected object information and the received V2X messages together in a sensor data sharing message for supporting a specific service. In addition, a method of generating/transmitting a sensor data sharing message that provides an effect as if the sensor coverage were extended, by identifying the presence/state of objects located outside the sensor coverage based on received messages will also be described.

According to the methods proposed in the present disclosure, it is possible to expect an effect of improving detection capability by including V2X message information of objects that could not be detected for unexpected reasons within the coverage of existing mounted sensors or an effect of extending the detection coverage by including V2X message information of objects located within a newly extended coverage range of the sensors.

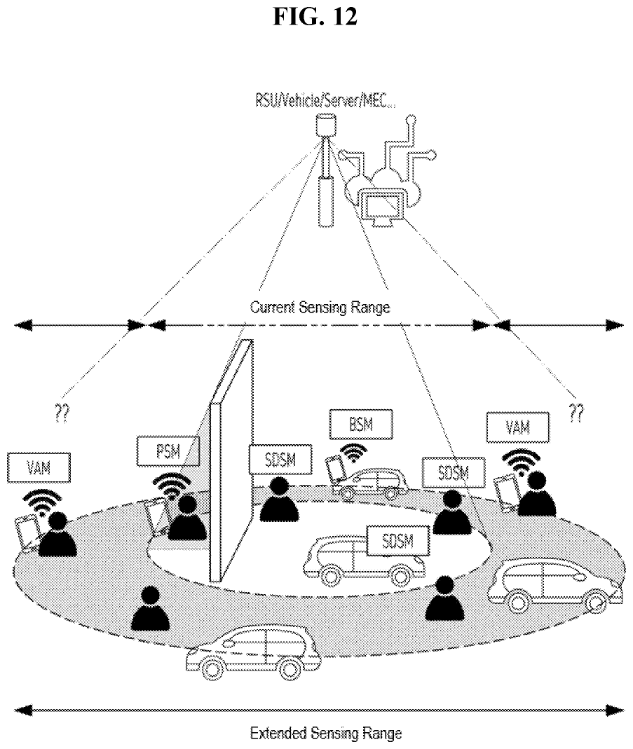

FIG. 12 illustrates an example of using detected objects and received V2X messages for improving/extending sensor coverage.

A server (or RSU/UE) may obtain object information located inside or outside the sensing coverage thereof through sensors installed/connected to the server (or RSU/UE). On the other hand, the server (or RSU/UE) may obtain such information by receiving awareness messages (or proxy awareness messages) and/or messages for (raw/processed) sensor data sharing purposes from surrounding servers/RSUs/UEs. Based on the analysis results, the server (or RSU/UE) determines the validity of object information to be included in a sensor data sharing message format for a specific purpose. Criteria for determining the validity may include whether a V2X message contains sufficient information for identifying an object and the validity of the V2X service. When the system performs a function of parsing message information to determine the validity of the information, if the V2X message contains insufficient information for identifying the object, the information may be excluded from candidate targets for inclusion.

When object information to be messaged is determined through validity verification, the server (or RSU/UE) may notify the target object of a target message for conversion that the information thereof will be converted into the sensor data sharing message format generated by the server/RSU/UE and propagated to other V2× objects.

From the perspective of gains for extending the sensing coverage, when the server (or RSU/UE) directly generates a single sensor data sharing message, requirements for including both sensor-detected object information and information acquired and processed from messages received by a designated ITS station in the sensor data sharing message format may be summarized. For the expansion of the collected V2X messages, the received messages may be input into the message format by considering sensing coverage-in, out, and in & out.

Redundancy mitigation rules and/or object inclusion rules for objects to be included in messages (e.g., CPM, SDSM) defined in sensor data sharing service standards may be processed in combination with the contents proposed in the present disclosure.

Information of objects to be included in the sensor data sharing message format may be quantified data of objects derived from sensor data, and the information may also be aggregated in the form of V2X messages. When both sensor data and V2X messages of the corresponding object are obtained, analyzed quantified data in a fused form of the two may be input into the message format to improve data quality. The requirements of such an input method may vary depending on the sensing capability requirements of the server (or an RSU/UE) and the sensing time point of the object to be included in the sensor data sharing message.

The server (or RSU/UE) may include both object information detected by the sensor within an arbitrarily designated extended sensor coverage range and information acquired from messages received by an ITS station that generates the sensor data sharing message in the sensor data sharing message format. In such a case, since it is likely that the arbitrarily extended sensor coverage range includes information received through V2X messages rather than sensor-detected object information, numerical data information for the extended sensor coverage needs to be included in the message.

The server (or RSU/UE) may represent, by using an extended/new data field, which event object information included in the message data format to be received by a server (or RSU/UE) that will receive the sensor data sharing message format is related to. Alternatively, the server (or RSU/UE) may additionally represent detected source recognition information.

When a single sensor data sharing message format includes both object information detected by the sensor and information acquired or processed from messages received by the ITS station generating the sensor data sharing message, it may be necessary to provide a method of distinguishing between objects detected by the sensor and objects for which data fields need to be filled with information acquired from received messages, in terms of V2X message exchange functionality.

### Classification of Collected Object Information and Verification of Data Validity for Determining Whether to Include or Exclude Collected Object Information Data for Sensing Coverage Extension in Sensor Data Sharing Message

A server (or RSU/UE) may collect object information located inside or outside the sensing coverage thereof in order to effectively support a sensor data sharing service or other V2X services.

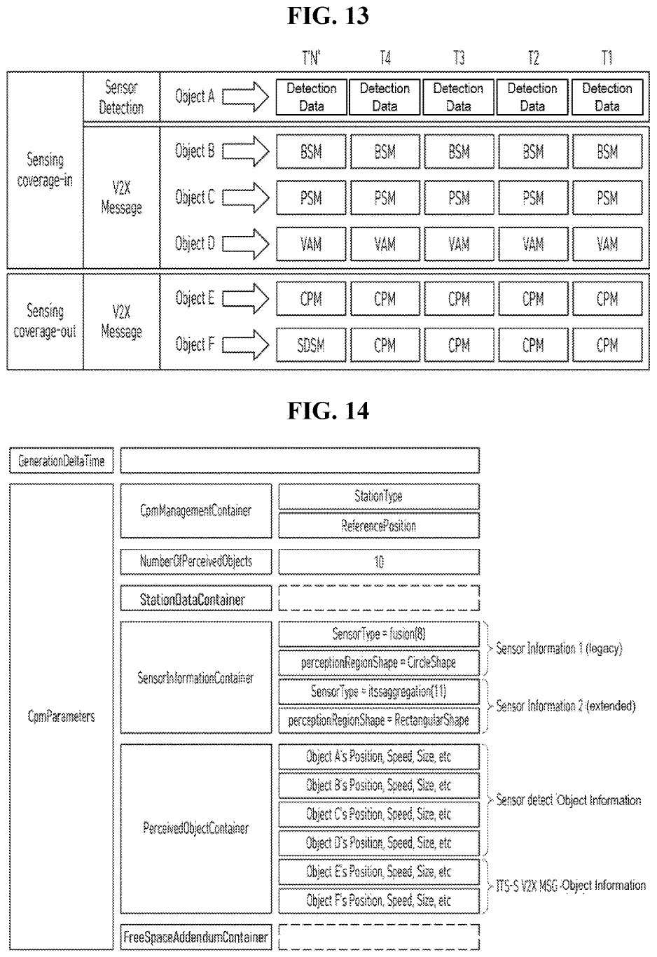

Such object information may be obtained through sensors (e.g., camera, LiDAR, etc.) installed/connected to the server (or RSU/UE), or the information may be obtained when the server (or RSU/UE) receives awareness messages (e.g., CAM, VAM, BSM, PSM, etc.), proxy awareness messages (e.g., SBSM), and/or messages for (raw/processed) sensor data sharing purposes (e.g., SDSM, CPM) from surrounding servers (or RSUs/UEs). Accordingly, the server (or RSU/UE) capable of collecting the above information should be able to classify the information based on certain conditions. FIG. 13 illustrates an example of message classification. For example, the system may perform classification according to sensing coverage in/out and the method of acquiring information data (e.g., sensor, V2X message) as mentioned above.

Moving objects and V2X messages with awareness attributes are detected or transmitted based on a specific time interval. Accordingly, when the server (or RSU/terminal) collects such messages, multiple detection data and messages detected or transmitted from the same object may be accumulated in chronological order.

When information data in the form of V2X messages are collected, detailed information of an object needs to be included such that sufficient information for identifying a single object is included in the V2X message. To determine the validity of the information, the system should be able to perform a function of checking whether the information is actually included in the message. Table 3 below shows examples of message fields of detailed information for object identification for performing such a system function.

TABLE 3
Fields related to detailed object identification information and examples of major
messages
(1) Information related to positioning
(i) BSM/PSM
Latitude, Longitude, Elevation, PositionalAccuracy
... /PathHistory/FullPositionVector
(ii) CAM, VAM
referencePosition
(2) Information data generation time
(i) BSM/PSM
DDateTime
(ii) CAM/VAM
generationDeltaTime
(3) Fields related to speed and acceleration information and examples of major
messages
(i) BSM/PSM
Speed, AccelerationSet4Way
(ii) CAM/VAM
Speed, longitudinalAcceleration
(4) Fields related to direction information and examples of major messages
(i) BSM/PSM/CAM/VAM
Heading, SteeringWheelAngle
(5) Fields related to size information and examples of major messages
(i) BSM
VehicleSize
(ii) CAM
VehicleLength, VehicleWidth
(6) Fields related to PathHistory information and examples of major messages
(i) BSM
BSMpartIIExtension / VehicleSafetyExtensions / PathHistory / PathHistoryPointList /
... ...
(ii) PSM
PathHistory / PathHistoryPointList
(iii) CAM
CoopAwareness / CamParameters / LowFrequencyContainer /
BasicVehicleContainerLowFrequency / PathHistory
(iv) VAM
vruMotionPredictionContainer / pathHistory
(7) Fields related to PathPrediction information and examples of major messages
(i) BSM
BSMpartIIExtension / VehicleSafetyExtensions / PathPrediction / RadiusOfCurvature /
... ...
(ii) PSM
PathPrediction / RadiusOfCurvature
(iii) VAM
vruMotionPredictionContainer / pathPrediction
(iv) CAM

When the system performs the function of parsing message information to determine the validity of the information, if a V2X message contains insufficient information for identifying an object, the information may be excluded from candidate targets for inclusion. For example, when the confidence level of a specific information data field is below a certain requirement value, the information may be regarded as low-reliability information and excluded. Examples of message fields of such information are shown below.

### CAM

Basic VehicleContainerHighFrequency/DF_Speed/SpeedConfidence/::=INTEGER {equalOrWithinOneCentimeterPerSec (1), equalOrWithinOneMeterPerSec (100), outOfRange(126), unavailable(127)} (1 . . . 127)→e.g., when outOfRange(126)

The server (or RSU/UE) may also consider the validity of a V2X service as another criterion for collecting object information located inside or outside the sensing coverage. That is, instead of checking whether object identification information is included for collection, when collecting object information located inside or outside the sensing coverage, the server (or RSU/UE) does not need to continuously perform detection or include received messages if there are areas or objects irrelevant to a specific V2X service user,

For example, in basic safety-related use cases such as receiving awareness messages including a BSM or PSM to recognize dangerous situations and warn the user, it is unnecessary to collect object information about objects existing in areas or events occurring outside the scope related to the safety of a user receiving V2X messages. Accordingly, it may be more efficient to prioritize detection for areas relevant to the V2X user, i.e., the valid reception range of the V2X service user or collect V2X messages in such areas.

When valid V2X service area/object information is collected with priority, priority detection areas/objects (e.g., areas/objects with high risk factors in the expected travel path of a V2X UE and surrounding areas) and subsequent detection areas/objects, or areas/objects to be omitted or abandoned for detection (e.g., areas already passed by the V2X UE, or areas/objects in the expected travel path and surrounding areas of the V2X UE in which risk factors are very low or nonexistent when considering speed, direction, and Time to Collision (TTC)) may be determined by tracking movement and state information.

As examples of verifying the validity of such V2X services, the following two situations may be considered.

1) From the standpoint/perspective of a server (or RSU/UE) generating/transmitting a message, valid V2X service objects/areas determined to be valid may be identified, and the generated/transmitted sensor data message may include valid object/area information irrelevant to a receiving server (or RSU/UE).

In such a case, the message inclusion priority of an object expected to be associated with an event may be set higher than that of other objects. Examples of such events may include obstacles and collision/risk situations, and the inclusion priority of objects related to such events may be set higher than that of other objects, thereby having priority in aspects such as the arrangement order of object data in a data frame or the transmission order.

In addition, the receiving server (or RSU/UE) may also represent which event the object information included in the received sensor data sharing message format is related to, by using an extended/new data field in the message. For example, new event information data may be defined, or existing ITIS code information may be used for input.

2) From the standpoint/perspective of a server (or RSU/UE) receiving a message, valid V2X service objects/areas may be identified, and a generated/transmitted sensor data message may include only valid object/area information meaningful to the receiving server (or RSU/UE).

In this case, when an accident risk or an event risk is detected, the server (or UE/RSU) may transmit not only a sensor data sharing message but also a direct event information message immediately.

When the above validity verification is completed, the server (or RSU/UE) may notify the target object of the a message for conversion that the information thereof will be converted into the sensor data sharing message format generated by the server/RSU/UE and propagated to other V2× objects. The transfer of such information may have various options depending on the purpose of the service or the operation method/policy, such as unilateral transmission or proceeding to the next step after requesting consent.

### Tracking of Object Information Located Outside Sensing Coverage

If the server (or RSU/UE) detects an object located outside the sensor coverage thereof, the server (or RSU/UE) may perform one or more of the following operations: (a) requesting the UE that transmits the object information to continue transmitting the object-related information (for a specified time duration); or (b) if messages containing the object information are no longer received for a specified time duration, transmitting a message for verifying whether the existence/state of an object changes to the server/RSU/UE that detects the object and transmits a sensor data sharing message, or to another ITS station that is determined to be located in the vicinity of the object, thereby enabling the tracking/identification of the state/existence/position of the object.

Input of Collected Object Information Data for Sensing Coverage Extension into Sensor Data Sharing Message Format

As described above, there may be various methods for inputting information to be transmitted in a sensor data sharing message format by verifying the validity of information data of sensing object information collected inside/outside the sensing coverage and V2X message information.

From the perspective of gain for extending the sensing coverage, when a single sensor data sharing message is directly generated by the server (or RSU/UE), the requirements for including both the object information detected by a sensor and the information acquired and processed from messages received by a designated ITS station into the sensor data sharing message format are summarized. For the purpose of expansion of the collected V2X messages, the following message format input may be considered for the received messages.

### (1) Sensing Coverage-In

(i) Information on an object that is not detected by the sensor of the server/RSU/UE may be included as a new object in a message for sensor data sharing generated by the server/RSU/UE, and (ii) among the objects detected by the sensor, if the information of the corresponding object (e.g., position, size, speed/acceleration/heading, path-history/prediction) included in the message received by the server/RSU/UE has higher precision/reliability/accuracy than the information determined or calculated by the sensor, the information may be corrected/updated and included in the message for sensor data sharing generated by the server/RSU/UE.

The same or similar redundancy mitigation rule and/or object inclusion scheme defined in the ETSI CPS TR/TS may be combined with the above-mentioned methods (1) and (2) to determine whether information is to be included in a single message for sensor data sharing generated and transmitted by the server/RSU/UE.

### (2) Sensing Coverage-Out

The information may be converted into an object information format and included in a message for sensor data sharing generated by the server/RSU/UE. Alternatively, containers included in a received awareness (or proxy) message may be included in the message for sensor data sharing, or the received (or proxy) awareness message may be forwarded to the UEs in the vicinity thereof.

When the server/RSU/UE includes information of an ITS station located outside the coverage of the sensor thereof (acquired from a message received by the server/RSU/UE) in the message for sensor data sharing to be transmitted, sensor information in a sensor information container included in the message for sensor data sharing may include one or more of local aggregation, ITS-s aggregation, and fused object information. The fused object information may be obtained by fusing sensing information of a plurality of sensors installed in a single server/RSU/UE, the fused object information may be obtained by a server/RSU/UE fusing sensing information of sensors installed in different servers/RSUs/UEs, or the fused object information may be obtained by a server/RSU/UE fusing sensing information acquired by the sensor thereof (or a sensor of another server/RSU/UE) with information acquired from a received V2X message.

### (3) Sensing Coverage-In & Out

When both information of objects included in the sensing coverage and information of objects not included in the sensing coverage are received, a messages generated by the server/RSU/UE may be configured such that information of a new object located inside or outside the sensing coverage (and not included in previous message transmission) is assigned a higher (or equal) priority than objects included in the sensing coverage that are transmitted previously (or within a specific reference time after message transmission).

In addition, the above operation may be applied only when the information of the ITS station acquired from a message received by the server/RSU/UE has precision/reliability/accuracy equal to or higher than a (predetermined/agreed) specific level.

### (4) Distinction Between Objects Detected by Sensor and Objects Perceived Through Message Reception

When both object information detected by a sensor and information data acquired or processed from a message received by an ITS station generating the sensor data sharing message are included together in the same sensor data sharing message format, it may be necessary to provide a method for distinguishing whether the corresponding object is an object detected by the sensor or an object for which data fields are configured based on the received message.

### Method of Indicating Sensing Coverage Extension Information in Sensor Data Sharing Message Format

1. Input for Conversion of ITS Station Information Included in Message into Object Information

The server (or RSU/UE) parses target message(s) for conversion whose validity is verified, converts the message(s) into data to be included in a data frame related to a sensing object information list of the sensor data sharing message format, and inputs the converted data therein.

In this case, since the purpose of the object information input into the data frame related to the sensing object information list of the sensor data sharing message format is sensing coverage extension, the above object information is assumed to be included together with the object information detected by the sensor.

According to the current relevant standards for the data element field of the sensing object information list of the sensor data sharing message format, the data frame structure of PerceivedObjectContainer may be used in the case of a CPM, and the data frame structure of DetectedObjectList may be used in the case of an SDSM. Hereinafter, examples for filling such data frame structures will be described. However, in addition to these examples, field items to be included in data frame structures related to object information of the sensor data sharing message format may be modified or added depending on the type of sensor data sharing message.

The process of converting message(s) into the data frame of the sensor data sharing message format needs to determine and input a value that is identical to the contents of mandatory information included in the target message for conversion or a value most closely matches within the range of the same attribute information.

(1) Example of Conversion with Reference to Sensor Measurement Time-Related Information

### (i) Target Message for Conversion→CPM

PerceivedObjectContainer/measurementDeltaTime DeltaTimeMilliSecondSigned
   When the target message for conversion is a CAM or VAM, the difference between generationDeltaTime and the time at which the message is received by the server (or RSU/UE) is input by referencing generationDeltaTime information included in the message.
   When the target message for conversion is a BSM or PSM, the difference between DSecond and the time at which the message is received by the server (or RSU/UE) is input by referencing DSecond information included in the message.

### (ii) Target Message for Conversion→SDSM

DetectedObjectData/DetectedObjectCommonData/MeasurementTimeOffset
   When the target message for conversion is a CAM or VAM, the difference between generationDeltaTime and the time at which the message is received by the server (or RSU/UE) is input by referencing generationDeltaTime information included in the message.
   When the target message for conversion is a BSM or PSM, the difference between DSecond and the time at which the message is received by the server (or RSU/UE) is input by referencing DSecond information included in the message.
      (2) Example of Conversion with Reference to Sensor Measurement Relative Position Information

### (i) Target Message for Conversion→CPM

PerceivedObjectContainer/position CartesianPosition3dWithConfidence (xCoordinate, yCoordinate, zCoordinate)
   When the target message for conversion is a CAM or VAM, DF_Speed, DF_ReferencePosition, DF_Heading, and DE_DriveDirection are referenced, and the predicted result values of the relative position and accuracy information from the location of a sensor mounted on the server (or RSU/UE) are input into the above DE information.
   When the target message for conversion is a BSM or PSM, DE_Speed, DE_Latitude, DE_Longitude, DE_Elevation, and DE_Heading are referenced, and the predicted result values of the relative position and accuracy information from the location of a sensor mounted on the server (or RSU/UE) are input into the above DE information.
   In the current CPM example, x, y, and z information respectively represent the East, North, and Vertical directions, or the x, y, and z information may be expressed as Latitude, Longitude, and Elevation.

### (ii) Target Message for Conversion→SDSM

PositionOffsetXYZ/offsetX, offsetY, offsetZ ObjectDistance information

The information may be input according to the same approach as in the CPM example.

(3) Example of Conversion with Reference to Sensor Measurement Object Relative Speed-Related Information

### (i) Target Message for Conversion→CPM

PerceivedObjectContainer/velocity Velocity3dWithConfidence
   When the target message for conversion is a CAM or VAM, DF_Speed, DF_ReferencePosition, DF_Heading, and DE_DriveDirection are referenced, and the predicted result values of the relative speed and accuracy information from the location of a sensor mounted on the server (or RSU/UE) are input into the above DE information.
   When the target message for conversion is a BSM or PSM, DE_Speed, DE_Latitude, DE_Longitude, DE_Elevation, and DE_Heading are referenced, and the predicted result values of the relative speed and accuracy information from the location of a sensor mounted on the server (or RSU/UE) are input into the above DE information.
   In the current CPM example, x, y, and z information respectively represent the East, North, and Vertical directions, or the x, y, and z information may be expressed as Latitude, Longitude, and Elevation.

### (ii) Target Message for Conversion→SDSM

Speed, SpeedConfidence
   When the target message for conversion is a CAM or VAM, DF_Speed is referenced, and an identical value or the most similar value selected from among the above DE information is input.
   When the target message for conversion is a BSM or PSM, DE_Speed is referenced, and an identical value or the most similar value selected from among the above DE information is input. If there is no confidence-related information available for reference, a value determined by the server (or RSU/UE) may be input.
      (4) Example of Conversion with Reference to Sensor Measurement Object Relative Acceleration-Related Information

### (i) Target Message for Conversion→CPM

PerceivedObjectContainer/velocity Velocity3dWithConfidence
   When the target message for conversion is a CAM or VAM, longitudinalAcceleration, lateralAcceleration, and verticalAcceleration are referenced, and an identical value or the most similar value selected from among the above DE information is input.
   When the target message for conversion is a BSM or PSM, DF_AccelerationSet4Way (long Acceleration, lat Acceleration, vert VerticalAcceleration, yaw YawRate) is referenced, and an identical value or the most similar value selected from among the above DE information is input.

### (ii) Target Message for Conversion→SDSM

AccelerationSet4Way/Acceleration, VerticalAcceleration, AccelerationConfidence, YawRate, YawRateConfidence

The input may be performed using the same approach as in the CPM example. However, for yawRate-related information, data may be input by referencing the yawRate-related data frame/element included in each message.

(5) Example of Conversion with Reference to Sensor Measurement Object Type-Related Information

### (i) Target Message for Conversion→CPM

ObjectClassDescription/ClassConfidence, class CHOICE (VehicleSubclass or PersonSubclass or AnimalSubclass or AnimalSubclass)
   When the target message for conversion is a CAM or VAM, an identical value selected from among the above selection values is input by referencing StationType information included in the message.
   When the target message for conversion is a BSM, the most similar value selected from among the above selection values is input by referencing Supplemental VehicleExtensions/Basic VehicleClass information. If the Basic VehicleClass information is not available, the value may be input as passengerCar (5).
   When the target message for conversion is a PSM, the most similar value selected from among the above selection values is input by referencing PersonalDeviceUserType information.

### (ii) Target Message for Conversion→SDSM

DetectedObjectData/DetectedObjectCommonData/ObjectType, ClassificationConfidence
   When the target message for conversion is a CAM or VAM, the most similar value selected from among the above selection values is input by referencing StationType information included in the message.
   When the target message for conversion is a BSM, the most similar value selected from among the above selection values is input by referencing Supplemental VehicleExtensions/Basic VehicleClass information. If Basic VehicleClass information is not available, the value may be input as vru (3).
   When the target message for conversion is a PSM, the most similar value selected from among the above selection values is input by referencing PersonalDeviceUserType information.

### 2. Input of Numerical Data Information for Extension of Sensor Information Coverage

The server (or RSU/UE) may arbitrarily designate an extended sensor coverage range. Then, the server (or RSU/UE) may include, in a sensor data sharing message format, both object information detected by a sensor within the range and information data acquired or processed from a message received by an ITS station generating the sensor data sharing message. In such a case, since it is likely that the arbitrarily extended sensor coverage range includes information received through V2X messages rather than sensor-detected object information, numerical data information for the extended sensor coverage needs to be included in the message to enable the receiving system m to recognize the extended sensing results compared with the original sensing coverage.

For a sensor data sharing message format having a data frame capable of representing sensor information-related data, the extended sensing coverage information may be represented by using sensor type and sensing (detection) area information. If necessary, additional information may be included to quantify and represent various extended coverage areas.

### (1) Example of Inputting Numerical Data Related to Extension of Sensor Information Coverage

### (i) CPM

SensorInformationContainer/SensorInformation
   Addition of a new SensorInformation structure
SensorInformationContainer/SensorInformation/SensorType=itssaggregation(11)
   Input of a type related to V2X messages received by an ITS station (itssaggregation) into Sensor Type
DetectionArea/VehicleSensor or AreaRadial or AreaPolygon or AreaCircular . . . and the like
   Input of numerical sensing area data into data frame information

### (ii) SDSM

Currently, the SDSM does not have a data frame capable of representing sensor information-related data. However, when a related data frame is added in the future, an identical value or the most similar value from among the above DF/DE information may be input and represented.

### 3. Input of Additional Information for Object Information of ITS Station Information Included in Message

The server (or RSU/UE) may also represent which event the object information included in a message data format received by the server (or RSU/UE) subject to receiving the sensor data sharing format message is related to by using an extended/new data field in the message. Alternatively, the server (or RSU/UE) may additionally represent detected source recognition information.

### (1) Example of Inputting Event Data-Related Information

### (i) CPM

PerceivedObjectContainer/
   Addition of a new eventCase data frame structure
PerceivedObjectContainer/eventCase: select and input one from among unknown (0), obstacle (1), collision (2), road_hazard_risk (3), . . .

### (ii) SDSM

DetectedObjectData/DetectedObjectCommonData/
   By adding a new eventCase data frame structure, the input may be performed using the same approach as in the CPM example.

### (2) Example of Inputting Perception Data-Related Information

### (i) CPM

PerceivedObjectContainer/
   Addition of a new sourceData data frame structure
PerceivedObjectContainer/sourceData/SourceType::select one from among Unknown (0), Sensor (1), ITS-S Message (2), and Fusion (3).
PerceivedObjectContainer/sourceData/SensorID: select input from among Unknown (0), Lidar (1), Camera (2), . . .
PerceivedObjectContainer/sourceData/MessageID: select from among BSM (20), PSM (30), . . .
. . .

### (ii) SDSM

DetectedObjectData/DetectedObjectCommonData/
   By adding a new sourceData data frame structure, the input may be performed using the same approach as in the CPM example.

### 4. Distinction Between Objects Detected by Sensor and Objects Perceived Through Message Reception

It may be necessary to distinguish between objects detected by a sensor and objects for which data fields are configured based on received messages. The reasons for requiring such distinction are as follows.
In the case of an object for which data fields need to be filled based on received messages, it may be necessary for the receiving UE to also recognize that the information included in a sensor information data container is not valid.
The definition of the confidence level for information related to a detected object may differ from the definition of the confidence level for information related to an object for which the data field needs to be filled based on received messages.

Examples of major methods for distinguishing such information are as follows.
A method may be considered in which a set of object IDs assigned to objects detected by the sensor and a set of object IDs assignable to objects for which data fields need to be filled based on received messages are used in a mutually exclusive manner.
As in NumberOfPerceivedObjects of a CPM, when both object information detected by a sensor and information acquired from a message received by an ITS station generating the sensor data sharing message are included together in one sensor data sharing message, a data element indicating the number of sensor-detected objects and a data element indicating the number of objects for which data fields are filled based on received messages may be include in the sensor data sharing message.
An operation in which the server/RSU according to the present disclosure fuses multiple types of messages to generate a new type of information/category may be regarded as a new service provided by the server/RSU. When a sensor data sharing message is generated, a <sensor data sharing message including only object information obtained from general sensor data> and a <sensor data sharing message generated based on message aggregation> use the same format, but the messages may appear as different messages/services. In this case, instead of including the messages together in a single format, it may also be possible to use different message IDs such that the receiving UE distinguishes between the two types of messages by the message IDs.
It may also be possible to add a small-sized data frame, which is capable of representing detected source recognition information, to each object data included in an information data frame (e.g., PerceivedObjectContainer or DetectedObjectData) of sensor-detected objects included in a sensor data sharing message format, thereby including all of the source type (e.g., Unknown (0), Sensor (1), ITS-S Message (2), Fusion (3), . . . ), sensor ID, and message ID (e.g., BSM (20), PSM (30), . . . ).

FIG. 14 illustrates an example of a CPM. In FIG. 14, a sensor-detected object message and ITS-S V2X messages are shown together. Referring to FIG. 14, PerceivedObjectContainer may include a plurality of pieces of object information (e.g., position, speed, size, etc.). For example, objects A to D may be sensor-detected object information directly detected by an ITS station, and objects E and F may be information acquired from V2X messages received by the ITS station from another ITS station. SensorInformationContainer may include first sensor information and second sensor information. The first sensor information may provide sensor information (e.g., sensor type, sensing area, etc.) for the sensor-detected object information directly detected by the ITS station, and the second sensor information may provide sensor information (e.g., sensor type, sensing area, etc.) acquired by the ITS station through the V2X messages received from another ITS station.

StationDataContainer and FreeSpaceAddendumContainer are optional data containers provided when the target message for conversion is converted into a CPM defined in the ETSI standard. StationDataContainer and FreeSpaceAddendumContainer may be omitted in the CPM depending on the embodiment. Meanwhile, a data container is a higher-level data bundle that groups detailed data having similar attributes.

Meanwhile, StationDataContainer and FreeSpaceAddendumContainer (or corresponding information) may be provided not only when the target message for conversion is a CPM defined in the ETSI standard, but also when the target message for conversion is converted into an SDSM defined in the SAE standard.

The ITS service operation layer standard is under development, with service phases being standardized into Day-1 and Day-2 according to the technically feasible period, the degree of autonomous driving support, and whether basic safety support or additional convenience is provided. Day-2 services include platooning, VRU protection, sensor sharing services, and maneuver cooperation services, which enhance traffic safety and improve driving and traffic convenience through autonomous driving support and additional convenience services.

The sensor sharing service is a service that shares surrounding environment information identified by sensors mounted on vehicles and RSUs through V2X communication. The main purpose of the sensor sharing service is to extend the detectable area of the service user and improve the recognition rate of road situations in blind spots by sharing information on the current driving environment (e.g., road users without V2X capability, obstacles, etc.) detected by the sensors of a vehicle and RSU (e.g., radar, LiDAR, camera), thereby enhancing traffic safety.

According to the methods proposed in the present disclosure, the server/RSU/UE may acquire ITS station information in an area not detected by the sensor thereof through reception of a V2X message and include and transmit the information in a message for sensor data sharing, thereby obtaining the effect of improving sensing sensitivity or extending coverage.

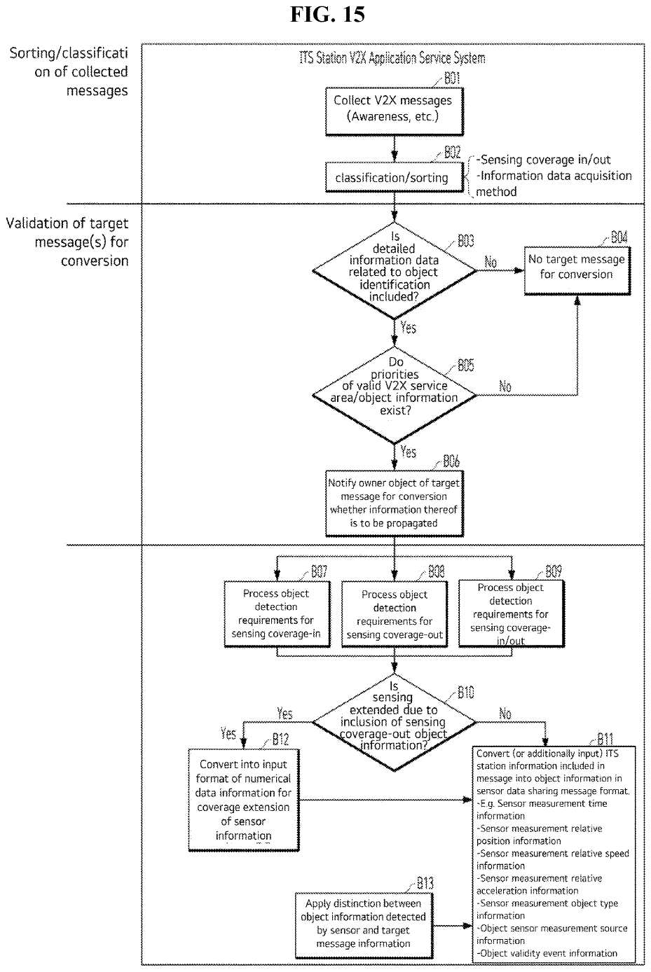

FIG. 15 illustrates an example of a procedure of processing input for a sensor data sharing message format.

Referring to FIG. 15, a device (e.g., server/RSU/UE) may receive/collect V2X messages from other devices (B01). The device may classify/sort the V2X messages based on whether the V2X messages are inside or outside sensing coverage, data acquisition methods, and the like.

The device may check whether the V2X message includes detailed data related to object identification (B03) and exclude V2X messages not including the detailed data from conversion targets (B04). Even when a priority is configured for determining a valid V2X service area or a valid object (B05), if a V2X message does not satisfy the priority, the V2X message may also be excluded from the conversion targets (B04).

The device may notify a target (owner) object of a target message for conversion that information of the target (owner) object is to be propagated (B06).

The device may process requirements related to object detection by considering sensing coverage in/out/in & out (B07, B08, and B09).

When sensing coverage out object information is included, the device may input numerical data for coverage extension into the sensor data sharing message format (B12).

The device may input the above-described additional information into the sensor data sharing message format (B11).

Meanwhile, information for distinguishing between objects detected by a sensor and objects for which data fields are configured based on received messages may be included in the sensor data sharing message format (B13).

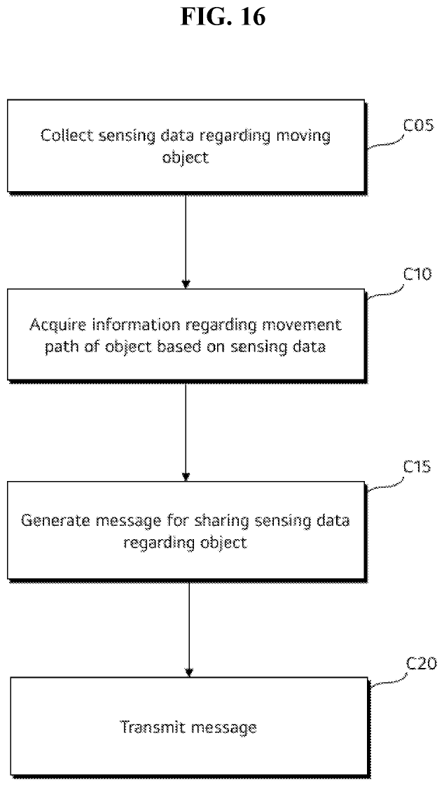

FIG. 16 illustrates a flow of a method in which a first device transmits data in an ITS according to an embodiment. The first device may include at least one of a UE, a vehicle, an RSU, or a server.

Referring to FIG. 16, the first device may collect sensing data regarding a moving object (C05).

The first device may acquire information regarding a movement path of the object based on the sensing data (C10).

The first device may generate a message (e.g., CPM, SDSM, etc.) for sharing the sensing data regarding the object (C15).

The first device may transmit the message to the second device (C20).

The message may include N data sets configured based on the information regarding the movement path of the object, and the N data sets may be related to the position of the object at each of N different time points.

The position of the object at each of the N different time points may be determined by the first device based on the information regarding the movement path of the object.

The movement path of the object may be a path along which the object is predicted to move, and the N data sets may be related to the position of the object predicted at N future time points.

The movement path of the object may be a path of the movement history of the object, and the N data sets may be related to the position of the object at N past time points.

The sensing data regarding the moving object may be acquired from V2X messages received from other devices.

The message may include information regarding a confidence level for the N data sets configured based on the movement path of the object.

The message may further include at least one data set configured based on the sensing data, in addition to the N data sets.

The message may include information for distinguishing whether each data set is a data set configured based on the information regarding the movement path or a data set configured based on the sensing data.

The sensing data may include first sensing data acquired within sensing coverage of the first device and second sensing data acquired outside the sensing coverage of the first device.

The second sensing data may be received from another device having sensing coverage different from the sensing coverage of the first device.

Although not limited thereto, various descriptions, functions, procedures, proposals, methods, and/or operational flow charts of the present disclosure disclosed in this document may be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

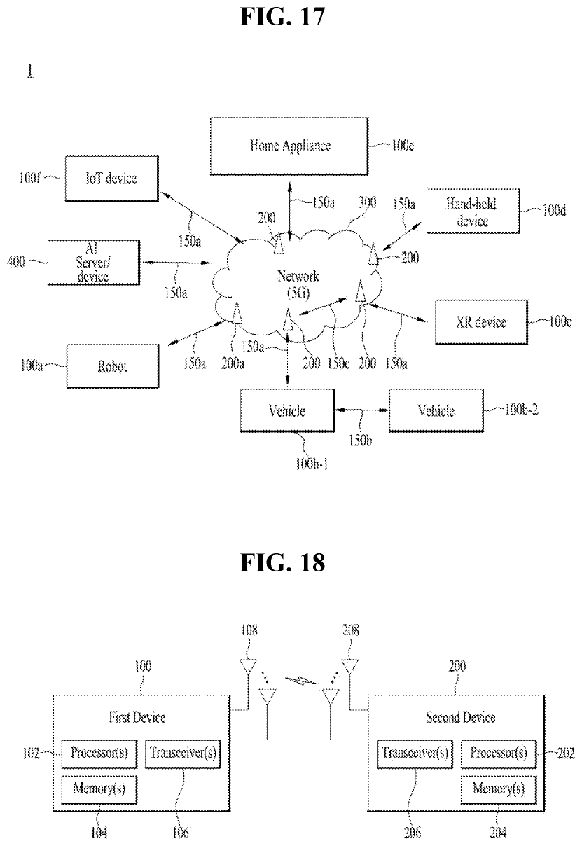

FIG. 17 illustrates a communication system applied to the present disclosure.

Referring to FIG. 17, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g., relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

FIG. 18 illustrates a wireless device applicable to the present disclosure.

Referring to FIG. 18, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 17.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

Specifically, a UE may include the processor(s) 102 connected to the RF transceiver and the memory(s) 104. The memory(s) 104 may include at least one program for performing operations related to the embodiments described above with reference to FIGS. 11 to 27.

Alternatively, a chipset including the processor(s) 102 and memory(s) 104 may be configured. The chipset may include: at least one processor; and at least one memory operably connected to the at least one processor and configured to, when executed, cause the at least one processor to perform operations.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

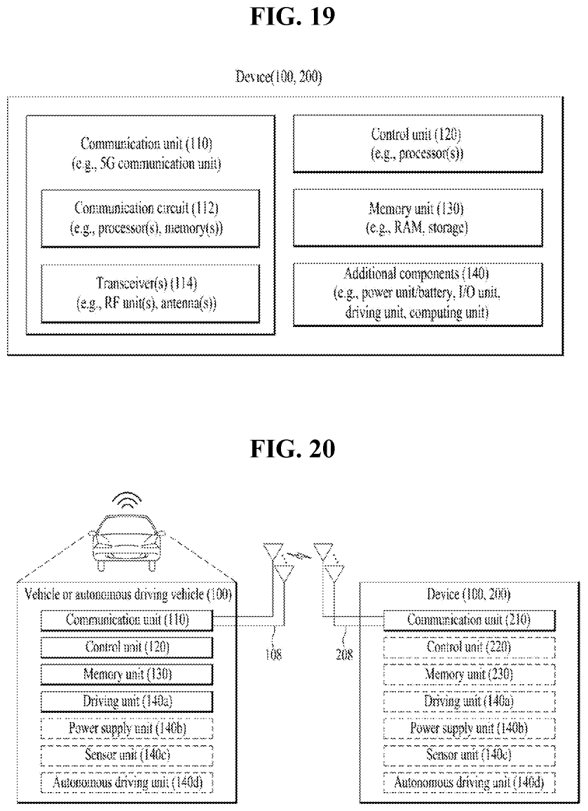

FIG. 19 illustrates another example of a wireless device applied to the present disclosure. The wireless device may be implemented in various forms according to a use-case/service (refer to FIG. 17)

Referring to FIG. 19, wireless devices 100 and 200 may correspond to the wireless devices 100 and 200 of FIG. 18 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 18. For example, the transceiver(s) 114 may include the one or more transceivers 106 and 206 and/or the one or more antennas 108 and 208 of FIG. 18. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 17), the vehicles (100b-1 and 100b-2 of FIG. 17), the XR device (100c of FIG. 17), the hand-held device (100d of FIG. 17), the home appliance (100e of FIG. 17), the IoT device (100f of FIG. 17), a digital broadcast terminal, a hologram device, a public safety device, an MTC device, a medicine device, a fintech device (or a finance device), a security device, a climate/environment device, the AI server/device (400 of FIG. 17), the BSs (200 of FIG. 17), a network node, etc. The wireless device may be used in a mobile or fixed place according to a use-example/service.

In FIG. 19, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

FIG. 20 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 20, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 19, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). Also, the driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the acquired data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly acquired data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

Here, wireless communication technologies implemented in the wireless devices (XXX, YYY) of the present specification may include LTE, NR, and 6G, as well as Narrowband Internet of Things for low power communication. At this time, for example, the NB-IoT technology may be an example of a Low Power Wide Area Network (LPWAN) technology, and may be implemented in standards such as LTE Cat NB1 and/or LTE Cat NB2, and is not limited to the above-described names. Additionally or alternatively, the wireless communication technology implemented in the wireless devices (XXX, YYY) of the present specification may perform communication based on LTE-M technology. In this case, as an example, the LTE-M technology may be an example of LPWAN technology, and may be referred to by various names such as eMTC (enhanced machine type communication). For example, LTE-M technology may be implemented in at least one of a variety of standards, such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless devices (XXX, YYY) of the present specification is at least one of ZigBee, Bluetooth, and Low Power Wide Area Network (LPWAN) considering low power communication, and is not limited to the above-described names. As an example, ZigBee technology may generate personal area networks (PANs) related to small/low-power digital communication based on various standards such as IEEE 802.15.4, and may be called various names.

The embodiments described above are those in which components and features of the present disclosure are combined in a predetermined form. Each component or feature should be considered optional unless explicitly stated otherwise. Each component or feature may be implemented in a form that is not combined with other components or features. In addition, it is also possible to constitute an embodiment of the present disclosure by combining some components and/or features. The order of operations described in the embodiments of the present disclosure may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

In this document, embodiments of the present disclosure have been mainly described based on a signal transmission/reception relationship between a terminal and a base station. Such a transmission/reception relationship is extended in the same/similar manner to signal transmission/reception between a terminal and a relay or a base station and a relay. A specific operation described as being performed by a base station in this document may be performed by its upper node in some cases. That is, it is obvious that various operations performed for communication with a terminal in a network comprising a plurality of network nodes including a base station may be performed by the base station or network nodes other than the base station. The base station may be replaced by terms such as a fixed station, a Node B, an eNode B (eNB), an access point, and the like. In addition, the terminal may be replaced with terms such as User Equipment (UE), Mobile Station (MS), Mobile Subscriber Station (MSS).

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means.

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure. For example, those skilled in the art may use the components described in the foregoing embodiments in combination. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The above-described embodiments of the present disclosure are applicable to various apparatuses in ITS.

1. A method performed by a first device, the method comprising:
collecting sensing data regarding a moving object;
acquiring information regarding a movement path of the object based on the sensing data;
generating a message for sharing the sensing data regarding the object; and
transmitting the message to a second device,
wherein the message comprises N data sets configured based on the information regarding the movement path of the object, and
wherein the N data sets are related to a position of the object at each of N different time points.

2. The method of claim 1, wherein the position of the object at each of the N different time points is determined by the first device based on the information regarding the movement path of the object.

3. The method of claim 1, wherein the movement path of the object is a path along which the object is predicted to move, and
wherein the N data sets are related to the position of the object predicted at N future time points.

4. The method of claim 1, wherein the movement path of the object is a path of movement history of the object, and
wherein the N data sets are related to the position of the object at N past time points.

5. The method of claim 1, wherein the sensing data regarding the moving object is acquired from vehicle-to-everything (V2X) messages received from other devices.

6. The method of claim 1, wherein the message comprises information regarding a confidence level for the N data sets configured based on the movement path of the object.

7. The method of claim 1, wherein the message further comprises at least one data set configured based on the sensing data in addition to the N data sets.

8. The method of claim 7, wherein the message comprises information for distinguishing whether each data set is a data set configured based on the information regarding the movement path or a data set configured based on the sensing data.

9. The method of claim 1, wherein the sensing data comprises first sensing data acquired within sensing coverage of the first device and second sensing data acquired outside the sensing coverage of the first device.

10. The method of claim 9, wherein the second sensing data is received from another device having sensing coverage different from the sensing coverage of the first device.

11. A non-transitory computer-readable recording medium having recorded thereon a program for executing the method of claim 1.

12. A first device comprising:
a memory configured to store instructions; and
a processor configured to perform operations by executing the instructions,
wherein the operations performed by the processor comprise:
collecting sensing data regarding a moving object;
acquiring information regarding a movement path of the object based on the sensing data;
generating a message for sharing the sensing data regarding the object; and
transmitting the message to a second device,
wherein the message comprises N data sets configured based on the information regarding the movement path of the object, and
wherein the N data sets are related to a position of the object at each of N different time points.

13. The first device of claim 12, wherein the first device is a user equipment (UE), a vehicle, a road side unit (RSU), or a server.
